(19) United States
(12) Patent Application Publication
(10) Pub. No.: US 2017/0307789 A1
(43) Pub. Date: Oct. 26, 2017

(54) LIGHT REDIRECTING FILM CONSTRUCTIONS AND METHODS OF MAKING SAME

(71) Applicant: 3M INNOVATIVE PROPERTIES COMPANY, St. Paul, MN (US)

(72) Inventors: Manoj Nirmal, St. Paul, MN (US); Bing Hao, Woodbury, MN (US); Erik A. Aho, New Richmond, WI (US); John F. Reed, North Oaks, MN (US); Charles A. Marttila, Shoreview, MN (US); Michael Benton Free, Baytown, MN (US); John P. Baetzold, North St. Paul, MN (US)

(21) Appl. No.: 15/515,951

(22) PCT Filed: Oct. 9, 2015
(86) PCT No.: PCT/US2015/054830

§ 371 Date: Mar. 30, 2017

Related U.S. Application Data
(60) Provisional application No. 62/065,932, filed on Oct. 20, 2014.
(60) Provisional application No. 62/186,871, filed on Jun. 30, 2015.

(51) Int. Cl. G02B 5/02; F21S 11/00

(52) U.S. Cl. CPC G02B 5/0231; F21S 11/00

(57) ABSTRACT

Articles and methods of making light redirecting film constructions including a micro structured optical film bonded in selected areas to another film, and including a diffuser are described. The diffuser has an optical haze in the range of (20) to (85) percent and an optical clarity of no greater than (50) percent. The diffuser may be a surface diffuser and may be an asymmetric surface diffuser.

### BACKGROUND

A variety of approaches are used to reduce energy consumption in buildings. Among those approaches is the more efficient use of sunlight to provide lighting inside buildings. One technique for supplying light inside of buildings, such as in offices, residential buildings, etc. is the redirection of incoming sunlight. Because sunlight enters windows at a downward angle, much of this light is not useful in illuminating a room. However, if the incoming downward light rays can be redirected upward such that they strike the ceiling, the light can be more usefully employed in lighting the room.

Daylight Redirection Films (DRFs), provide natural lighting by redirecting incoming sunlight upward, onto the ceiling. This can lead to significant energy savings by reducing the need for artificial lights. Light Redirection Films can consist of linear optical microstructures that reflect incoming sunlight onto the ceiling. DRFs are typically installed on the upper clerestory section of windows 7′ (2.1 m) and above. A typical configuration is shown in FIG. 1.

Sunlight that would normally land on the floor can be used to provide natural lighting by using suitable constructions involving daylight redirecting films. FIGS. 2A-2B show an example of the amount of light that can be redirected from the floor to the ceiling by the use of a DRF. The bright spot on the floor in FIG. 2A is redirected toward the ceiling and back wall in FIG. 2B due to the presence of the light redirecting film 201.

Buildings (residential & commercial) account for about 40% of all energy consumed and lighting represents about 30% of that energy. Substituting even a fraction of artificial lighting with natural light can yield significant energy savings. The Illuminating Engineering Society of North America (IES) has developed a comprehensive daylight illuminance metric, named spatial Daylight Autonomy or sDA that characterizes the efficacy of daylighting systems. An extensive study conducted at several Department of

Defense sites across the U.S. demonstrated that installation of 3M daylight redirecting film (DRF) increases sDA values. In addition to energy savings, daylighting has soft benefits related to increased worker productivity, elevated test scores, and improved mood and energy.

A problem that is frequently encountered when an area is illuminated using natural daylight is how to spread the light adequately and evenly. In the case, for example, in which an area is being illuminated within a building, there will usually be parts of that area that are less well lit than others, and also some locations where the users of the building are troubled by glare from the light source. One solution to address this problem is the use of a diffuser.

In general, microstructured light redirecting films may be fragile under certain circumstances because the microstructured features may be subject to mechanical damage and/or chemical damage (e.g.

window cleaners). One challenge when attempting to protect the microstructured elements in a DRF is that the lamination process to add a cover or protective layer can cause damage to those microstructured elements. The same challenge is present when attempting to laminate any other type of functional layer or film, such as a diffuser, to a DRF on the side of the microstructured elements. Additionally, the presence of an additional layer next to the DRF may also modify its optical properties and significantly decrease or nullify its light redirecting properties.

### SUMMARY

In some aspects of the present description, an article including a light redirecting layer comprising a first major surface and a second major surface, one or more barrier elements, and an adhesive layer is provided. The light redirecting layer includes one or more microstructured prismatic elements on its first major surface defining a light redirecting area. The total surface area of the one or more barrier elements is greater than 60% of the light redirecting area. The adhesive layer includes a first major surface and a second major surface, where the first major surface of the adhesive layer has a first region and a second region, the first region of the first surface of the adhesive layer is in contact with one or more barrier elements, and the second region of the first surface of the adhesive layer is in contact with one or more microstructured prismatic elements. The article allows transmission of visible light and either at least one of the one or more barrier elements or an optional diffuser disposed adjacent the adhesive layer has an optical haze of 20 to 85 percent and an optical clarity of no more than 50 percent.

In some aspects of the present description, a film including an article is provided. The article includes a light redirecting layer comprising a first major surface and a second major surface, one or more barrier elements, and an adhesive layer. The light redirecting layer includes one or more microstructured prismatic elements on its first major surface defining a light redirecting area. The total surface area of the one or more barrier elements is greater than 90% of the light redirecting area. The adhesive layer has a first major surface and a second major surface, where the first major surface of the adhesive layer has a first region and a second region, the first region of the first surface of the adhesive layer is in contact with one or more barrier elements, and the second region of the first surface of the adhesive layer is in contact with one or more microstructured prismatic elements.
The article further includes a first substrate adjacent the second major surface of the adhesive layer. The first substrate includes a diffuser having an optical haze of 20 to 85 percent and an optical clarity of no more than 50 percent. The article further includes a window film adhesive layer adjacent the second surface of the light redirecting layer.
The article allows transmission of visible light and the film optionally further comprises a liner immediately adjacent the window film adhesive layer.

In some aspects of the present description, a film including an article is provided. The article includes a light redirecting layer comprising a first major surface and a second major surface, one or more barrier elements, an adhesive layer, a diffuser adjacent the second major surface of the light redirecting layer, a first substrate immediately adjacent the adhesive layer, and a window film adhesive layer immediately adjacent the first substrate. The light redirecting layer includes one or more microstructured prismatic elements on its first major surface defining a light redirecting area, and the total surface area of the one or more barrier elements is greater than 90% of the light redirecting area. The adhesive layer includes a first major surface and a second major surface, where the first major surface of the adhesive layer has a first region and a second region, the first region of the first surface of the adhesive layer is in contact with one or more barrier elements, and the second region of the first surface of the adhesive layer is in contact with one or more microstructured prismatic elements. The article allows transmission of visible light and the film optionally further comprises a liner immediately adjacent the window film adhesive layer. The diffuser has an optical haze of 20 to 85 percent and an optical clarity of no more than 50 percent.

In some aspects of the present description, a film including an article is provided. The article includes a light redirecting layer comprising a first major surface and a second major surface, one or more barrier elements, an adhesive layer, a diffuser adjacent the second major surface of the light redirecting layer. The diffuser has an optical haze of 20 to 85 percent and an optical clarity of no more than 50 percent. The light redirecting layer includes one or more microstructured prismatic elements on its first major surface defining a light redirecting area, and the total surface area of the one or more barrier elements is greater than 90% of the light redirecting area. The adhesive layer includes a first major surface and a second major surface, where the first major surface of the adhesive layer has a first region and a second region, the first region of the first surface of the adhesive layer is in contact with one or more barrier elements, and the second region of the first surface of the adhesive layer is in contact with one or more microstructured prismatic elements. The article allows transmission of visible light and the film optionally further comprises a liner immediately adjacent the adhesive layer.

In some aspects of the present description, an article including a light redirecting layer comprising a first major surface and a second major surface, one or more barrier elements, and an adhesive layer is provided. The light redirecting layer includes one or more microstructured prismatic elements on its first major surface defining a light redirecting area, and the total surface area of the one or more barrier elements in at least a portion of the article defined as a light redirecting region is greater than 60% of the light redirecting area. The adhesive layer includes a first major surface and a second major surface, where the first major surface of the adhesive layer has a first region and a second region, the first region of the first surface of the adhesive layer is in contact with one or more barrier elements, and the second region of the first surface of the adhesive layer is in contact with one or more microstructured prismatic elements. The article allows transmission of visible light and the one or more barrier elements comprises a diffuser having an optical haze of 20 to 85 percent and an optical clarity of no more than 50 percent.

In some aspects of the present description, a method of making an article is provided. The method includes providing a first substrate having a first major surface and a second major surface opposite the first major surface, applying an adhesive layer to the first major surface of the first substrate where the adhesive layer has a first major surface and a second major surface opposite the first major surface and where the second major surface of the adhesive layer is immediately adjacent the first major surface of the first substrate, printing one or more barrier elements on the first major surface of the adhesive layer, structuring a surface of at least some of the one or more barrier elements to form a diffuser comprising the structured surface, setting the one or more barrier elements, and laminating a light redirecting layer on the first major surface of the adhesive layer. The light redirecting layer includes one or more microstructured prismatic elements on its first major surface defining a light redirecting area. The total surface area of the one or more barrier elements is greater than 60% of the light redirecting area. The first major surface of the adhesive layer has a first region and a second region, where the first region of the first surface of the adhesive layer is in contact with the one or more barrier elements, and the second region of the first surface of the adhesive layer is in contact with one or more microstructured prismatic elements. The article allows transmission of visible light and the diffuser has an optical haze of 20 to 85 percent and an optical clarity of no more than 50 percent.

Any of the diffusers of the present description may be surface diffusers and may be isotropic surface diffusers or may be asymmetric or anisotropic surface diffusers that include asymmetric light diffusing surface structures adapted to provide anisotropic diffusion of visible light.

### BRIEF DESCRIPTION OF THE DRAWINGS

FIG. 1 is a typical configuration showing the use of a daylight redirecting film (DRF), demonstrating light redirection after the light passed through a room-facing light redirecting layer;

FIGS. 2A-2B show an example of the amount of light that can be redirected from the floor to the ceiling by the use of a DRF;

FIG. 3 shows a visual example of a solar column (white bar) on a window;

FIG. 4A is a conoscopic plot of light transmitted through a DRF without a diffuser;

FIG. 4B is a conoscopic plot of light transmitted through a DRF with a diffuser;

FIG. 4C shows the bidirectional transmittance distribution function (BTDF) at zero degree elevation for light transmitted through a DRF with and without a diffuser;

FIG. 5A shows a configuration using two separate films for combining a diffuser layer with a DRF;

FIG. 5B shows a configuration using a single article combining a diffuser layer with a DRF;

FIG. 6 shows an example in which barrier elements (or “islands”) have been printed on an adhesive;

FIGS. 7A-7B are schematic diagrams of a typical process to bond a microstructured film to a second film;

FIG. 8 illustrates the phenomenon of “punch through” and one option to minimize it by using an opaque adhesive in certain areas;

FIGS. 9A-9C show patterns for barrier elements;

FIG. 10A is a conoscope plot illustrating punch through glare for single-film DRF/diffuser constructions;

FIG. 10B is a bar graph illustrating punch through glare for single-film DRF/diffuser constructions;

FIG. 11 is a schematic side view of a light redirecting article having both clear view-through regions and light redirecting regions;

FIG. 12 shows a room-facing configuration having a DRF and diffuser.

FIG. 13A shows a sun-facing configurations having a DRF and diffuser;

FIG. 13B shows a sun-facing configurations having a DRF and diffuser;

FIG. 14 shows an embodiment comprising see-through regions and light redirecting regions;

FIG. 15 shows an example of random-looking two-dimensional bather elements on an adhesive layer;

FIG. 16 shows an embodiment of a laminate comprising a DRF laminated to a film comprising barrier elements;

FIG. 17 is a cross-sectional view of a laminate, showing that adhesive may flow and fill the air gaps in the microstructures;

FIG. 18 shows the bidirectional transmittance distribution function (BTDF) at various illumination angles for light transmitted through a DRF with and without a diffuser;

FIG. 19 is a perspective view of a light redirecting article having light redirecting elements extending along a first direction and having lenticular diffusing elements extending along a second direction orthogonal to the first direction;

FIGS. 20-22 are optical micrographs of microstructured surfaces;

FIG. 23A shows a visual example of a solar column (white bar) on a window with a DRF;

FIG. 23B shows a visual example of a diffused solar column on a window with a DRF and a diffuser; and

FIG. 24 is a scatter plot of haze versus clarity for various diffusers.

### DETAILED DESCRIPTION

In the following description, reference is made to the accompanying drawings herein described. In certain cases, the Figures may depict, by way of illustration, several specific embodiments of the present disclosure. It is to be understood that other embodiments different from those explicitly depicted in the Figures are contemplated and may be made without departing from the scope or spirit of the present disclosure. The following detailed description, therefore, is not to be taken in a limiting sense.

The present description relates to articles and methods of making daylight redirecting film (DRF) constructions comprising a microstructured optical film, such as a DRF, bonded in selected areas to another film through an adhesive, and further comprising a diffuser. This type of assembly may serve various purposes. For example, the assembly may protect the structured film, provide additional functionality and/or facilitate attachment of the microstructured optical film to a mounting surface, such as a glazing or window pane. One of the goals of the present disclosure is to provide for film constructions that allow the bonding of a microstructured film, such as a DRF, to another functional film, without significantly sacrificing the optical performance of the microstructured film.

Some embodiments of the articles of the present description include one or more optically active areas within the microstructured optical film, as well as one or more partially optically active areas. Those areas may be partially active depending on whether the adhesive flows all the way to the bottom of the microstructure. In such a case, light redirection may still occur, but to a lesser degree. In the case of a light redirecting layer, the optically active areas allow the redirection of incident light. When incident light hits the one or more partially optically active areas, the light is not substantially redirected by the microstructured prismatic elements in the light redirecting layer. The one or more optically active areas include a material adjacent to the microstructured prismatic elements, such as air or any other synthetic alternatives, like aerogel, that have a refractive index that allows the microstructured prismatic elements to redirect light. The one or more partially optically active areas include a material, typically an adhesive (e.g., a pressure sensitive adhesive or any other suitable adhesive) adjacent to a portion of the microstructured prismatic elements. The presence of the adhesive degrades the ability to redirect light for the portions of the daylight redirecting layer that are directly adjacent thereto. The barrier elements of this disclosure, which typically have a refractive index similar to that of the refractive index of the DRF, assist in maintaining the redirecting properties of the microstructured prismatic elements by forming a “barrier” between the microstructured prismatic elements and the adhesive. The barrier elements allow the presence of a low index interface for the DRF structures (e.g., air or aerogel if desired). The refractive index difference between air and the DRF allows redirection of the incident light.

The barrier elements of the present disclosure have sufficient structural integrity to substantially prevent flow of the adhesive into the microstructured prismatic elements, which would displace the air. The barrier elements may be made from any suitably curable polymeric material. Exemplary materials for inclusion in the barrier elements include multi-functional or cross-linkable monomer, resins, polymeric materials, inks, dyes, and vinyls. Illustrative cross-linkable monomers include multi-functional acrylates, urethanes, urethane acrylates, siloxanes, and epoxies. In some embodiments, cross-linkable monomers include mixtures of multifunctional acrylates, urethane acrylates, or epoxies. In some embodiments, the barrier elements comprise a plurality of inorganic nanoparticles. The inorganic nanoparticles can include, for example, silica, alumina, or Zirconia nanoparticles. In some embodiments, the nanoparticles have a mean diameter in a range from 1 to 200 nm, or 5 to 150 nm, or 5 to 125 nm. In illustrative embodiments, the nanoparticles can be “surface modified” such that the nanoparticles provide a stable dispersion in which the nanoparticles do not agglomerate after standing for a period of time, such as 24 hours, under ambient conditions. In some embodiments, the barrier elements may also include particles for diffusion which may have a mean diameter in a range of 200 nm to 8 micrometers or in a range of 500 nm to 4.5 micrometers, for example.

In some embodiments, the barrier element traps a low refractive index material (such as air or aerogel) in the area adjacent the microstructured prismatic elements.

In one embodiment, the present description is directed to an article comprising: a) a light redirecting layer comprising a first major surface and a second major surface; b) one or more barrier elements; and c) an adhesive layer; subject to the following conditions (see also FIGS. 11 to 13C):
the light redirecting layer comprises one or more microstructured prismatic elements on its first major surface defining a light redirecting area;
the total surface area of the one or more barrier elements is greater than 60% of the light redirecting area;
the adhesive layer comprises a first major surface and a second major surface;
the first major surface of the adhesive layer has a first region and a second region;
the first region of the first surface of the adhesive layer is in contact with one or more barrier elements;
the second region of the first surface of the adhesive layer is in contact with one or more microstructured prismatic elements;
the article allows transmission of visible light; and
at least one of the one or more barrier elements, or an optional diffuser disposed adjacent the adhesive layer has an optical haze of 20 to 85 percent and an optical clarity of no more than 50 percent. In other embodiments, the present disclosure is directed to films that comprise an article as described above. In yet other embodiments, the present disclosure is directed to windows comprising films or articles as described herein. In another embodiment, the present disclosure is directed to methods of making an article comprising: a) providing a first substrate having a first major surface and a second major surface opposite the first major surface; b) applying an adhesive layer to the first major surface of the first substrate (wherein the adhesive layer has a first major surface and a second major surface opposite the first major surface; and wherein the second major surface of the adhesive layer is immediately adjacent the first major surface of the first substrate); c) printing one or more barrier elements on the first major surface of the adhesive layer; d) structuring a surface of at least some of the one or more barrier elements to form a diffuser comprising the structured surface; e) setting the one or more barrier elements; and f) laminating a light redirecting layer on the first major surface of the adhesive layer; subject to the following conditions:
the light redirecting layer comprises one or more microstructured prismatic elements on its first major surface defining a light redirecting area;
the total surface area of the one or more barrier elements is greater than 60% of the light redirecting area;
the first major surface of the adhesive layer has a first region and a second region;
the first region of the first surface of the adhesive layer is in contact with the one or more barrier elements;
the second region of the first surface of the adhesive layer is in contact with one or more microstructured prismatic elements;
the article allows transmission of visible light; and
the diffuser has an optical haze of 20 to 85 percent and an optical clarity of no more than 50 percent.

Films and windows comprising the constructions disclosed in this application are also within the scope of the present disclosure.

All scientific and technical terms used herein have meanings commonly used in the art unless otherwise specified. The definitions provided herein are to facilitate understanding of certain terms used frequently in this application and are not meant to exclude a reasonable interpretation of those terms in the context of the present disclosure.

Unless otherwise indicated, all numbers in the description and the claims expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g. a range from 1 to 5 includes, for instance, 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The term “adhesive” as used herein refers to polymeric compositions useful to adhere together two components (adherents).

The term “window film adhesive layer” as used herein refers to a layer comprising an adhesive suitable to bond a film to a window or glazing, such as, for example, a pressure sensitive adhesive.

The term “adjacent” as used herein refers to the relative position of two elements, such as layers in a film construction, that are close to each other and may or may not be necessarily in contact with each other and may have one or more layers separating the two elements, as understood by the context in which “adjacent” appears.

The term “immediately adjacent” as used herein refers to the relative position of two elements, such as layers in a film construction, that are immediately next to each other without having any other layers separating the two elements, as understood by the context in which “immediately adjacent” appears.

The term “construction” or “assembly” are used interchangeably in this application when referring to a multilayer film, in which the different layers can be coextruded, laminated, coated one over another, or any combination thereof.

The term “light redirecting layer” as used herein refers to a layer that comprises microstructured prismatic elements.

The term “daylight redirecting film” (DRF) as used herein refers to a film that comprises one or more light redirecting layers and optionally other additional layers, such as substrates or other functional layers.

Light redirection, in general, may be called daylight redirection, sunlight redirection, or solar light redirection when the source of light is the sun.

The term “film” as used herein refers, depending on the context, to either a single layer article or to a multilayer construction, where the different layers may have been laminated, extruded, coated, or any combination thereof.

The term “barrier elements” as used herein refers to physical features laid on top of regions of an adhesive layer that help maintain the optical performance of the light redirecting layer when the adhesive layer and light redirecting layer are bonded to each other in opposing fashion. The barrier elements prevent the adhesive layer from filling the space surrounding microstructured prismatic elements and are able to provide an interface between the DRF and a low refractive index material, such as air or aerogel. In certain instances in this disclosure the barrier elements are also called “passivation islands,” or “islands.” Suitable barrier elements are described, for example, in U.S. provisional application (Attorney Docket No. 76730US002) titled “Barrier Elements for Light Directing Articles” filed on an even date herewith and hereby incorporated herein by reference to the extent that it does not contradict the present disclosure.

The term “microstructured prismatic element” as used herein refers to an engineered optical element, wherein at least 2 dimensions of the features are microscopic, that redirects input light with certain angular characteristics into output light with certain angular characteristics. In certain embodiments, the height of the microstructured prismatic element is less than 1000 micrometers. A microstructured prismatic element may comprise a single peak structure, a multipeak structure, such as a double peak structure, structures comprising one or more curves, or combinations thereof. The microstructured prismatic elements, including all of their physical and optical characteristics (e.g., glare, TIR angles, etc.), disclosed in U.S. provisional application No. 62/066307 titled “Room-Facing Light Redirecting Film with Reduced Glare” and in U.S. provisional application No. 62/066302 titled “Sun-Facing Light Redirecting Film with Reduced Glare,” both filed on Oct. 20, 2014, are hereby incorporated by reference to the extent that they do not contradict the present disclosure.

The term “diffusing agent” as used herein refers to features or additives incorporated in the article that increase the angular spread of light passing through the same article.

The term “repeating 1-dimensional pattern” as used herein refers to features that are periodic along one direction in reference to the article.

The term “repeating 2-dimensional pattern” as used herein refers to features that are periodic along 2 different directions in reference to the article.

The term “random-looking 1- or 2-dimensional pattern” as used herein refers to features that appear not to be periodic or semi-periodic along one or two different directions in reference to the article. Those features may still be periodic but with a period sufficiently larger than the mean pitch of individual features so that the period is not noticeable to most viewers.

As used herein, the index of refraction or refractive index of a material refers to the refractive index at 25 degrees C. and at a wavelength of 550 nm unless specified differently.

As used herein, the index of refraction of a material 1 (“RI1”) is said to “match” the index of refraction of a material 2 (“RI2”) if the value RI1 is within +/−5% of RI2.

For the following definitions of “room-facing” and “sun-facing,” it is assumed that a light redirecting layer has a first major surface and second major surface opposite the first major surface and that the first major surface of the DRF comprises microstructured prismatic elements.

As used herein, the term “room-facing,” in the context of a DRF or a construction comprising a DRF, refers to a film or construction where the incident light rays pass through the major surface of the DRF not containing the microstructured prismatic elements before they pass through the major surface that contains the microstructured prismatic elements. In the most typical configuration, when the DRF is located on an exterior window (i.e., when the window faces the exterior of a building), the microstructured prismatic elements in a “room-facing” configuration are oriented facing the interior of the room. However, the term “room-facing,” as defined herein can also refer to configurations where the DRF is on a glazing, or other kind of substrate, that does not face the exterior of the building, but is in between two interior areas.

As used herein, the term “sun-facing,” in the context of a DRF or a construction comprising a DRF, refers to a film or construction where the incident light rays pass through the major surface of the DRF containing the microstructured prismatic elements before they pass through the other major surface (the major surface not containing the microstructured prismatic elements). In the most typical configuration, when the DRF is located on an exterior window (i.e., when the window faces the exterior of a building), the microstructured prismatic elements in a “sun-facing” configuration are oriented facing the sun. However, the term “sun-facing,” as defined herein can also refer to configurations where the DRF is on a glazing that does not face the exterior of the building, but is in between two interior areas.

As used herein, the term “sealing” or “sealed” when referring to an edge of an article of this disclosure means blocking the ingress of certain undesired elements such as moisture or other contaminants.

The term “setting” as used herein refers to transforming a material from an initial state to its final desired state with different properties such as flow, stiffness, etc., using physical (e.g. temperature, either heating or cooling), chemical, or radiation (e.g. UV or e-beam radiation) means.

The term “visible light” as used herein refers to refers to radiation in the visible spectrum, which in this disclosure is taken to be from 400 nm to 700 nm.

In general, the present disclosure relates to articles and methods of making film constructions where two films are bonded to each other and at least one of the films comprises a microstructured optical film. In a typical example, the microstructured optical film may be a DRF. The disclosure in the application is exemplified by referring to DRFs and light redirecting layers as being part of the overall construction, but the concepts and subject matter taught and claimed in this application can extend to other microstructured optical films that are not DRFs.

The type of bonding disclosed and taught in this application between two films refers to bonding only via selected areas in the DRF in order to preserve the light redirecting function (or a suitable function in other microstructured optical films) of the film. Because the presence of the adhesive contacting the microstructured prismatic elements substantially destroys the ability to redirect light, there is a natural balance between the size of the areas that effect the bonding (partially optically active areas) between the two films and the size of the areas that are optically active (able to redirect light). That is, as the size of the bonding area between the two films increases, the strength of the bond increases, which is beneficial, but there is also less area left to perform the light redirecting function of the original DRF. Conversely, as the size of the light redirecting area increases, the higher amount of light is redirected, but the size of the area available for bonding decreases as does the strength of the bond between the two films.

The inventors of the present application have created articles where the optically area is greater than 90% of the total available area but that still have suitable bond strength to maintain both films bonded for certain applications, including preparation of window films for commercial, residential, and even automotive applications. The inventors have found that diffuser having certain characteristics, such as a haze in the range of 20 to 85 percent and a clarity of no more than 50 percent, are unexpectedly advantageous over other diffusers.

The type of construction proposed in this application may serve various purposes. For example, the assembly may protect the DRF, the second film to which the DRF is bonded may provide additional functionality, such as diffusion, and the construction may also facilitate attachment of the DRF to a mounting surface, such as a window.

Bonding the two films offers other significant advantages. For example, the resulting construction can have improved handling, rigidity, and provide the ability to attain thinner final constructions.

Basic Constructions

In some embodiments, the present disclosure is directed to an article comprising: a) a light redirecting layer comprising a first major surface and a second major surface; b) one or more barrier elements; and c) an adhesive layer; subject to the following conditions (see also FIGS. 11 to 13C):
the light redirecting layer comprises one or more microstructured prismatic elements on its first major surface defining a light redirecting area;
the total surface area of the one or more barrier elements is greater than 60% of the light redirecting area;
the adhesive layer comprises a first major surface and a second major surface;
the first major surface of the adhesive layer has a first region and a second region;
the first region of the first surface of the adhesive layer is in contact with one or more barrier elements;
the second region of the first surface of the adhesive layer is in contact with one or more microstructured prismatic elements;
the article allows transmission of visible light; and
at least one of the one or more barrier elements, or an optional diffuser disposed adjacent the adhesive layer has an optical haze in a range of 20 to 85 percent or in any of the other ranges described elsewhere herein, and an optical clarity of no more than 50 percent or an optical clarity in any of the other ranges described elsewhere herein.

In certain embodiments, the light redirecting layer comprises a light redirecting substrate, and the one or more microstructured prismatic elements are on the light redirecting substrate.

In other embodiments, to provide support to the microstructured prismatic elements, the constructions of this disclosure further comprise a first substrate adjacent the second major surface of the adhesive layer.

Diffusive Layers Coupled to DRFs

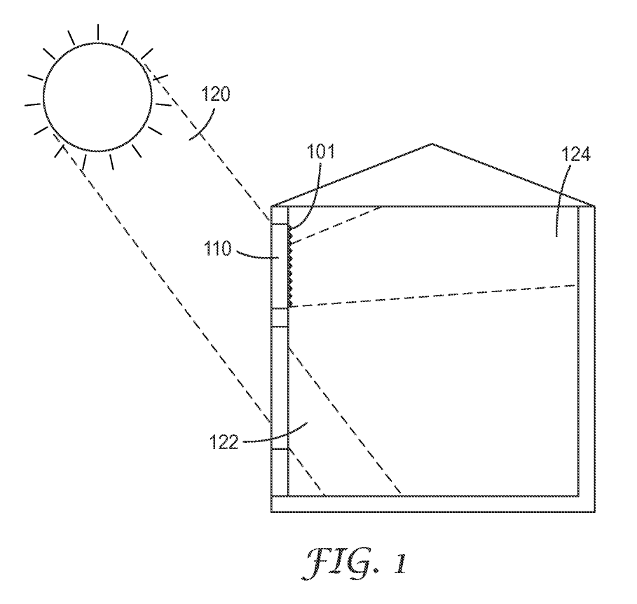

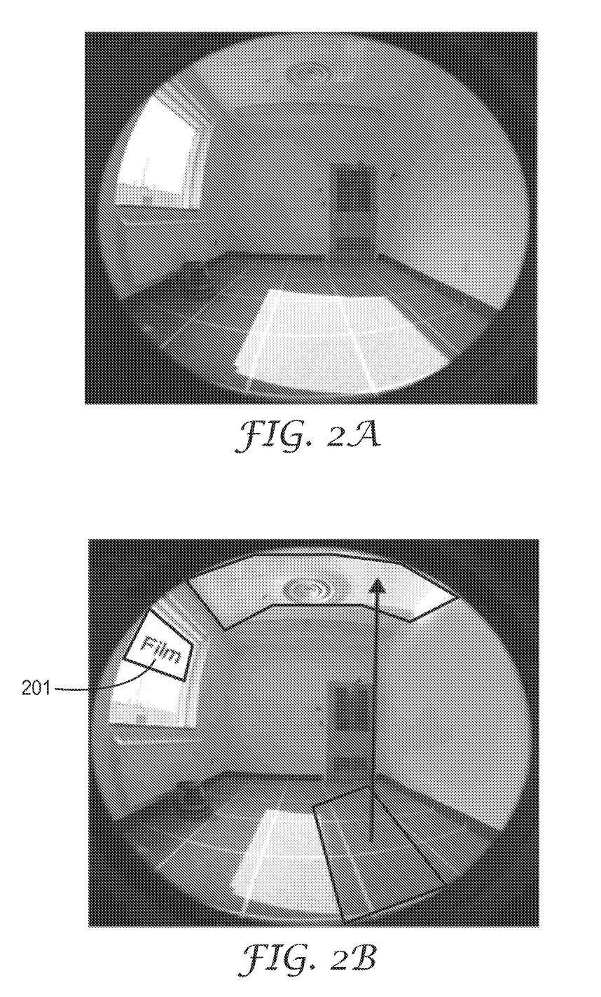

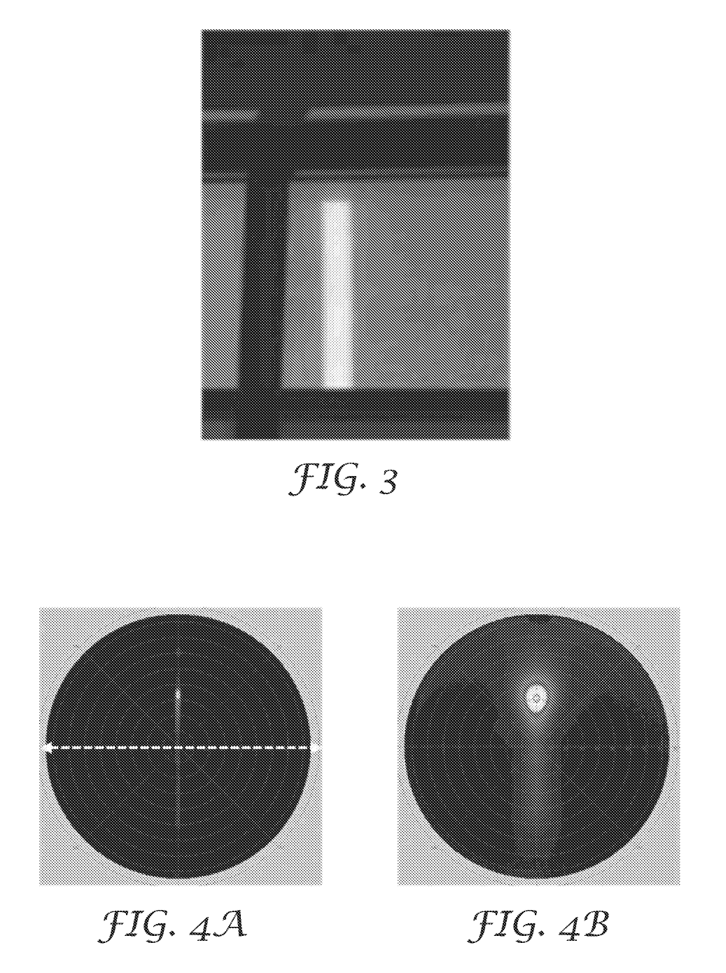

While one of the main incentives for using DRFs is energy savings, visual comfort needs to be taken in account. FIG. 1 illustrates a DRF 101 on a window 110. A portion of the sunlight 120 incident on window 110 is directed upward as deflected light 124 and a portion 122 is deflected downward. This downward light can cause glare for the occupants. In addition, since the microstructured prismatic elements are typically linear and oriented horizontally the incoming rays are refracted/reflected mainly in the vertical direction. Sunlight is highly collimated with about 0.5 degree spread and appears as a solar disk. The effect of the DRF is to spread this light vertically to form a solar column, such as that shown in FIG. 3.

A variety of articles have been developed to redirect sunlight to provide illumination within rooms. For example, the following patents and patent applications describe various DRFs and light redirecting microstructures: US Patent Publication No. 2008/0291541, titled “Light Redirecting Solar Control Film”, filed May 23, 2007 (Padiyath et al.) and pending U.S. Patent Applications Nos. 61/287360, titled “Light Redirecting Constructions” filed Dec. 17, 2009 (Padiyath et al), and 61/287354, titled “Light Redirecting Film Laminate” filed Dec. 17, 2009 (Padiyath et al.); PCT Application Publication No. WO 2012/134787, titled “Hybrid Light Redirecting and Light Diffusing Constructions”, filed Mar. 12, 2012 (Padiyath et al.), U.S. Pat. No. 5,551,042, titled “Structured Films and Use Thereof for Daylight Illumination”, issued Aug. 27, 1996 (Lea, et al.), US Patent Publication No. 2014/0211331, titled “Multiple Sequenced Daylight Redirecting Layers”, filed Mar. 27, 2014 (Padiyath et al.), US Patent Publication No. 2014/0198390, titled “Dual-sided Daylight Redirecting Film”, filed Mar. 27, 2014 (Padiyath, et al.), US Patent Publication No. 2008/0292820, titled “Light Diffusing Solar Control Film”, filed May 23, 2007 (Padiyath, et al.), U.S. Pat. No. 6,456,437, titled “Optical Sheets Suitable for Spreading Light”, issued Sep. 24, 2002 (Lea, et al.) The light redirecting films and light redirecting microstructures disclosed in the patents and patent applications in this paragraph are herein incorporated by reference to the extent that they do not contradict the present description. In general, any light redirecting film or layer, including those mentioned in this paragraph, and others known in the art, can be used in the constructions of this disclosure.

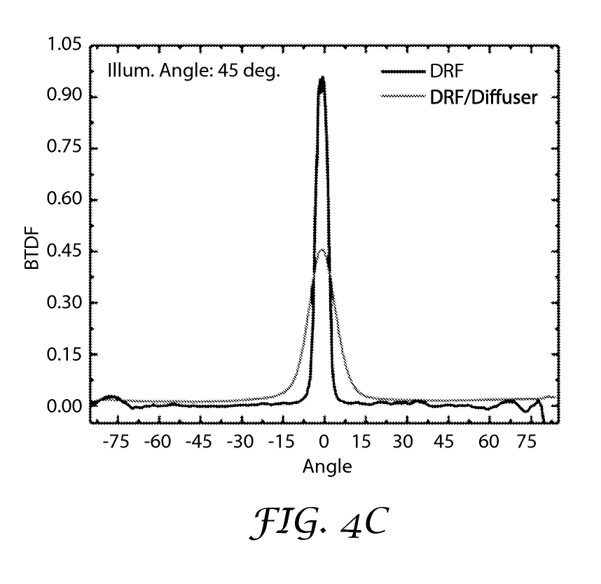

Both the total fraction of downward directed light and brightness of the solar column contribute to glare (visual discomfort). The brightness of the solar column depends on its angular spread. One solution to reduce glare is to introduce a diffuser layer in the optical path. The diffuser helps to spread out the solar column. In addition the diffuser layer can provide more uniform ceiling illumination by diffusing the upward directed light as shown in FIGS. 4A-4C. The light output distribution of bare DRF at 45 degree illumination angle is shown in FIG. 4A and the light output distribution of DRF/Diffuser (DRF before diffuser layer) at 45 degree illumination angle is shown in FIG. 4B. The diffuser layer spreads both the upward and downward directed light. The horizontal cross sections at 0 degree elevation for these cases are compared in FIG. 4C. The brightness of the solar column is proportional to the width and height of these peaks. The width of the peak increases and the peak height decreases by about two times with the addition of the diffuser. The use of the diffuser layer reduces glare and the visibility of the solar column significantly.

A variety of diffusers have been developed and are known in the art. For example, the following patents and patent applications describe various type of diffusers: U.S. Patent Publication No. 2014/0104689, titled “Hybrid Light Redirecting and Light Diffusing Constructions, filed Dec. 05, 2013, (Padiyath, et al.); PCT Application Publication No. WO 2014/093119, titled “Brightness Enhancing Film with Embedded Diffuser”, filed Dec. 05, 2013, (Boyd et al.); U.S. Pat. No. 6,288,172, titled “Light Diffusing Adhesive”, issued Sep. 11, 2001 (Goetz, et al.); PCT Application Publication No. WO 2013/158475, titled “Brightness Enhancement Film with Substantially Non-imaging Embedded Diffuser”, filed Apr. 12, 2013, (Boyd, et al.). The diffusers disclosed in the patents and patent applications in this paragraph are herein incorporated by reference to the extent that they do not contradict the present description. In general, any diffuser or diffusive layer, including those mentioned in this paragraph, and others known in the art, can be used in the constructions of this disclosure.

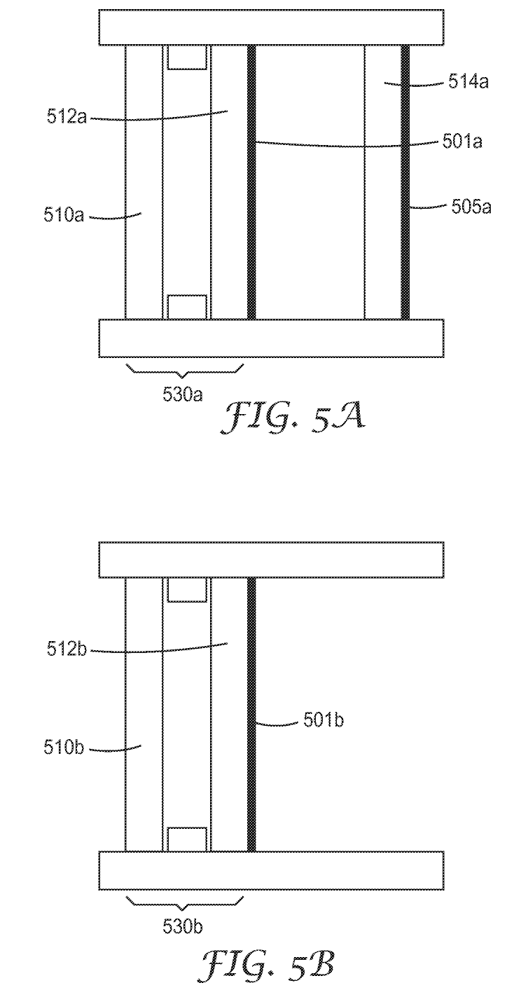

One option to combine the effect of a diffuser layer with a DRF is to adhere the DRF to the window and mount the diffuser to an added pane. This is illustrated in FIG. 5A which shows an insulated glazing unit 530a having first, second and third panes of glass 510a, 512a and 514a, respectively. A daylight redirecting film 501a is disposed on a surface of the second pane of glass 512a and a diffuser 505a is disposed on the third pane of glass 514b, which is an added pane. The present disclosure presents a solution where the diffuser layer and the DRF in a single construction. This is illustrated in FIG. 5B which shows an insulated glazing unit 530b having first and second panes of glass 510b and 512b, respectively. A light redirecting construction 501b is disposed on a surface of the second pane of glass 512b. The light redirecting construction 501b includes both elements for redirecting light, such as microstructured prismatic elements, and a diffuser.

In some embodiments, the diffusing properties can lie with the barrier elements, the adhesive, the window film adhesive, or any of the substrates that may be part of the light redirecting construction. In certain embodiments, the diffusing properties of any of the elements mentioned in the preceding sentence may be modified by introducing surface roughness, bulk diffusion, or using embedded diffusers.

In certain embodiments, the surface of a layer part of a light redirecting construction can be treated in such a manner that the layer diffuses visible light. Surface roughness to create diffusing properties in a layer can be accomplished by imparting a pattern or structure on the surface of a layer that increases the angular spread of input light in a desired manner. Some methods used to impart such a pattern include embossing, replication, and coating.

In other embodiments, bulk diffusion can be accomplished by adding one or more diffusing agents to the window film adhesive. Diffusing agents can comprise opaque particles or beads. Examples of diffusing agents include: polymeric or inorganic particles and/or voids included in a layer.

In yet other embodiments, a substrate or a layer part of a light redirecting construction can contain embedded diffusers. An embedded diffuser layer is formed in between the light redirecting layer and the substrate. This layer may consist of a matrix with diffusing agents. Alternatively the layer may be a surface diffuser layer consisting of a material with a refractive index sufficiently different from the light redirecting layer to obtain a desired level of diffusion. In other embodiments, various types of diffusers may also be used in combination.

Diffusers may be characterized by optical haze and/or optical clarity. Haze, or optical haze, can be measured as described in ASTM D1003-13 “Standard Test Method for Haze and Luminous Transmittance of Transparent Plastics”. Haze can be determined using a HAZE-GARD PLUS meter available from BYK-Gardner Inc. (Silver Springs, Md.) which is cited in the ASTM D1003-13 standard. Clarity, or optical clarity, can also be measured according to the ASTM D1003-13 standard by using the HAZE-GARD PLUS haze meter.

Typically, diffusers used in connection with DRFs have been high haze diffusers (e.g., greater than 90 percent haze). According to the present description, it has been found that diffusers (either separate diffuser layers of barrier elements adapted to diffuse visible light) having relatively low haze and relatively low clarity are particularly advantageous over other diffusers when used in or with a DRF. For example, suitable diffusers may have an optical haze in the range of 20 percent to 85 percent and an optical clarity of no more than 50 percent. Diffusers having an optical haze in the range of 20 percent to 75 percent and an optical clarity in the range of 5 percent to 40 percent have been found to be particularly advantageous. In some embodiments, the optical haze is in the range of 20, or 25 or 30 percent to 55, 57, 60, 65, 70, 75, 80, or 85 percent, and the optical clarity is in the range of 5, or 7, or 10 percent, to 35, or 37, or 40, or 45, or 50 percent.

It has been found that diffusers having a haze and a clarity in these ranges provide an angular spread of the solar column that substantially reduces glare while keeping the angular spread solar column sufficiently low that an occupant in a room with the DRF on a widow of the room can avoid the solar column altogether by small shifts in position. High haze is caused by wide angle scattering, while low clarity is caused by narrow angle scattering. It may be desired for the clarity to be low (e.g., less than 40 percent) and the haze to be low (e.g., less than 75 percent). Larger haze values (e.g., greater than 85 percent) can spread the solar column so that the bright region is diffuse but cannot be avoided by small shifts in position and could cause glare for multiple occupants. Higher clarity values (e.g., greater than 40 percent) may provide inadequate angular spread to reduce the high objectionable glare of the solar column.

Diffusers having useful haze and clarity values may be surface diffusers. The surface diffusers may be provided by including a layer or substrate having a structured surface adapted to diffuse visible light. Surface diffusers may include relief features created at an interface between two layers with one of the layers typically a low index layer such as air. The relief may be created in several ways. One approach is to include beads or particles loaded in a matrix. The beads may or may not have a refractive index matched to the refractive index of the matrix. Diffusion is caused by scattering off of bead surfaces exposed at the surface of the layer. If the beads and the matrix have differing refractive indices, the bulk of the layer can also contribute to diffusion. Haze and clarity may be adjusted by varying bead concentration, bead radius, exposed bead fraction, refractive index differences between the beads and the matrix, and the like. Diffuser punch through (which refers to light passing through the diffuser substantially without deflection—punch through is discussed further elsewhere herein) can be minimized using a high bead loading, but this can lead to multiple scattering events and undesirably large scattering of the light. It may be difficult to independently vary both haze and clarity using this approach since decreasing clarity typically increases haze.

Another approach to surface diffusers is to utilize engineered surfaces, which may be provided using methods described elsewhere herein. Such surfaces can have high coverage (e.g., greater than 90%) with little or substantially no flat area between surface features. Such coverage can reduce or even substantially eliminate diffuser punch through. The surface structure geometry may be precisely defined enabling substantially independent control of haze and clarity.

In some embodiments, a surface diffuser is provided by microstructuring a major surface of the barrier elements. In other embodiments, the surface diffuser may be provided on an additional layer or substrate included in the DRF.

In some embodiments, the diffuser or the barrier elements have a structured surface adapted to diffuse visible light. Such structured surfaces may provide isotropic or anisotropic diffusion. The structured surfaces may be formed as generally described in WO 2014/081693 (Pham et al.) or may be formed as generally described in U.S. Pat. No. 8,657,472 (Aronson et al.) or U.S. Pat. No. 8,888,333 (Yapel et al.), though in some cases it may be desired for the haze of the structured surface to be greater than those of the surfaces of U.S. Pat. No. 8,657,472 (Aronson et al.) or U.S. Pat. No. 8,888,333 (Yapel et al.). Each of WO 2014/081693 (Pham et al.), U.S. Pat. No. 8,657,472 (Aronson et al.), and U.S. Pat. No. 8,888,333 (Yapel et al.) are hereby incorporated by reference herein to the extent that they do not contradict the present description. In these approaches, a structured tool is provided and a structured layer is formed by casting and curing a curable (e.g., ultraviolet curable) resin against the structured tool.

In some embodiments, a structured surface is formed in the barrier elements by first making a film having a release-treated structured surface where the structured surface may be formed according to the approaches described elsewhere herein. The barrier elements may be printed and the release-treated structured surface placed onto the barrier elements. The barrier elements may then be cured through the film and then the film removed. An inverted form of the structured surface of the film can thereby be imparted into the surface of the barrier elements. A plurality of barrier elements may be included in the DRF and one or more, or all or substantially all, of the barrier elements may have a surface structure formed in this way.

In some cases it may be useful to characterize the surface of the diffusers of the present description in terms of the slope distributions of the surface. In some embodiments, no more than about 20 percent, or no more than about 10 percent, or no more than about 7 percent, or no more than about 5 percent, or no more than about 3 percent of the structured surface has a slope magnitude that is greater than about 20 degrees, greater than about 15 degrees, greater than about 10 degrees, or greater than about 7 degrees, or greater than about 5 degrees, or greater than about 3.5 degrees. In some embodiments, the structured surface may have steeper slopes. For example, in some embodiments, no more than about 20 percent, no more than about 10 percent, no more than about 7 percent of the structured surface has a slope magnitude that is greater than about 20 degrees, or greater than about 30 degrees, or greater than about 35 degrees or greater than about 40 degrees.

It may be desired for a large fraction, or substantially all of the structured surface to have a slope that contributes to the haze in order to avoid diffuser punch through. The structured surface may include microstructures, which may be protrusions or cavities, that may be closely packed, i.e., arranged such that at least portions of boundaries of many or most adjacent microstructures substantially meet or coincide. In some embodiments, a substantial fraction of the structured surface has a slope magnitude greater than 1 degree. In some embodiments, at least about 80 percent, or at least about 85 percent, or at least about 90 percent, or at least about 95 percent of the structured surface has a slope magnitude that is greater than 1 degree, or greater than 2 degrees, or greater than 3 degrees. In some embodiments, less than 5 percent, or less than 2 percent, or less than 1 percent of the structured surface has a slope magnitude that is less than 3 degrees, or less than 2 degrees, or less than 1 degree.

The structured surface can be characterized using atomic force microscopy (AFM) or confocal scanning laser microscopy (CSLM), for example, to determine a surface profile H(x,y) (i.e., a height, H, of the surface above a reference plane as a function of orthogonal in-plane coordinates x and y). Slopes Sₓ and S_{y} along respective x- and y-directions can then be calculated from the following two expressions:

Sₓ=∂H(x,y)/∂x

S_{y}=∂H(x,y)/∂x.

The slope magnitude Sₘ can be calculated from the following expression:

S_{y}=\sqrt{[∂H/∂x]²+[∂H/∂y]²}.

The distributions of the slope in the x-direction, the slope in the y-direction, and the slope magnitude can be determined.

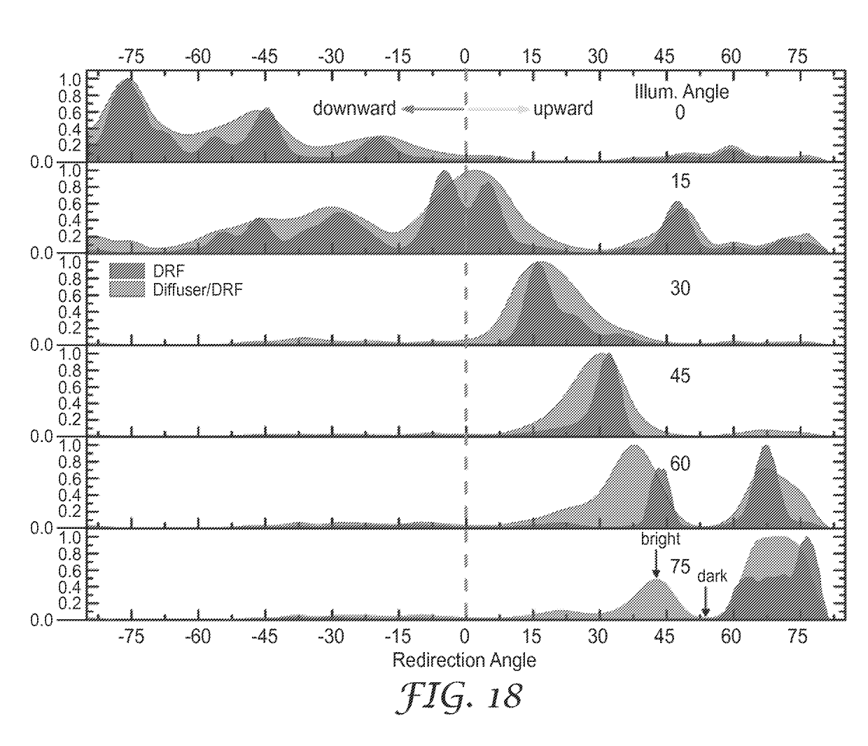

In some embodiments, the structured surface of the surface diffuser includes asymmetric light diffusing surface structures and the structured surface is configured to provide higher diffusion in a first direction than in a second direction orthogonal to the first direction. It may be desired to limit the diffusion along the vertical axis to minimize any downward redirection of light intended to be directed upward. In this case, the overall diffusion and glare would be limited if using an isotropic diffuser, while an anisotropic diffuser can provide a high degree of diffusion along the horizontal axis while limiting the diffusion along the vertical axis. In addition, for constructions in which the diffuser is placed before the DRF, an isotropic diffuser can cause undesirable bands in the output light. This is illustrated in FIG. 18 which shows the normalized bidirectional transmittance distribution function (BTDF) for light transmitted through a DRF at downward illumination angles from zero degrees to 75 degrees. An isotropic diffuser having a transmission of 92.7 percent, a haze of 66.9 percent, and a clarity of 8.8 percent was placed in front of a DRF (i.e., the diffuser was placed between the light source and the DRF). The general effect of the diffuser is to broaden all the redirected peaks. At 75 degrees illumination (the bottom row in the figure), the diffuser generates an additional bright band at about 42 degrees and a dark band centered at about 54 degrees. These alternating bands would be observable on the ceiling and may not be desirable. The corresponding results for an asymmetric or anisotropic diffuser configured to diffuse primarily in the horizontal direction is approximately the same as the undiffused DRF of FIG. 18 since the diffuser does not significantly affect the upward or downward redirection of light in this case. Anisotropic or asymmetric diffusers can be designed to minimize glare and mitigate the solar column effect by diffusing in the horizontal direction, without degrading the performance of the DRF by undesirably diffusing in the vertical direction.

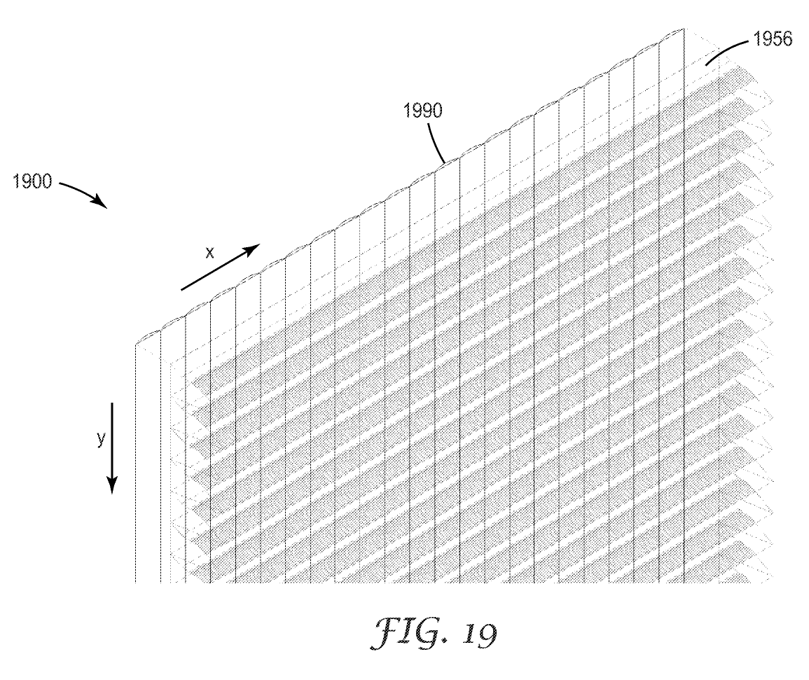

In some embodiments, the structured surface of the diffuser comprises lenticular elements as illustrated in FIG. 19 which is a perspective view of light redirecting assembly 1900 including a light redirecting layer having light redirecting elements 1956 extending along the x-direction, and including surface structures 1990 which are lenticular elements extending in the y-direction. The lenticular elements provide diffusion primarily in x or minus x directions with very little diffusion in the y or minus y directions. Such a diffuser can reduce or eliminate the undesirable bands in the output light that can be caused by an isotropic diffuser. The degree of diffusion (e.g., haze and/or clarity) of the lenticular array may be adjusted by varying the lenticular sag height and/or the radius of curvature.

In some cases it may be desired to provide a relatively high degree of diffusion in the horizontal direction and a smaller degree of diffusion in the vertical direction. Some degree of diffusion in the vertical direction may be desired to provide a more uniform lighting on the ceiling, for example. Suitable asymmetric diffusers that can provide a high degree of diffusion in a first direction and a lower but non-zero degree of diffusion in a second direction orthogonal to the first direction may be provided by structures elongated further in the second direction than the first direction and having differing radii of curvature in the first and second directions. The structures may be randomly or pseudo-randomly distributed on the diffusing surface in one or two in-plane directions.

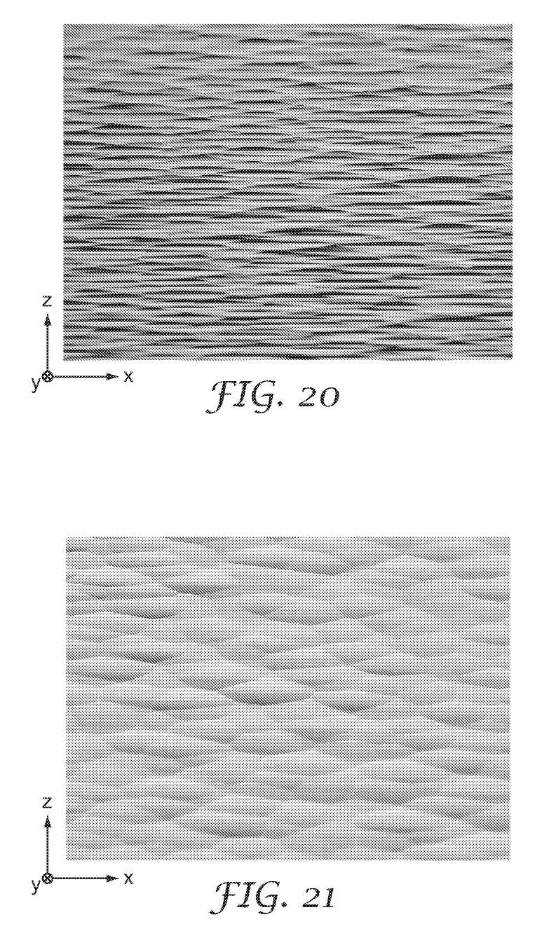

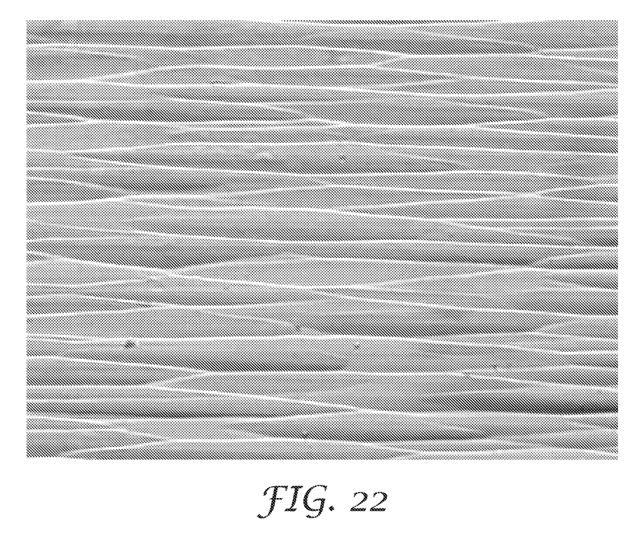

Suitable asymmetric diffusing surfaces are shown in FIGS. 20-22 which are top-view optical micrographs of samples that were made using a cutting tool to make patterned rolls which were subsequently microreplicated as described in U.S. Pat. No. 8,657,472 (Aronson et al.). The sample of FIG. 20 was geometrically asymmetric and had an asymmetric slope distribution. In particular, the sample had an average slope magnitude of about 0.07 degrees along the x-direction and an average slope magnitude of about 1.48 degrees along the y-direction. The sample of FIG. 21 was geometrically asymmetric and had an asymmetric slope distribution. In particular, the sample had an average slope magnitude of about 0.18 degrees along the x-direction and an average slope magnitude of about 0.85 degrees along the y-direction. The surface structures of the samples of FIGS. 20-22 may be described as approximately semi-ellipsoidal (half of an ellipsoid) or approximately semi-biconic (half of a bicone) structures.

In some embodiments, the surface structures extend in a first direction (e.g., the x-direction or the vertical direction) more than in the second direction (e.g., the y-direction or the horizontal direction) orthogonal to the first direction. In some embodiments, the surface structures have a first average length in the first direction and a second average length in the second direction. The first length divided by the second length may be described as an in-plane aspect ratio. In some embodiments, in-plane aspect ratio or the first length divided by the second length is greater than 1.1, or greater than 1.2, or greater than 1.5, or greater than 2, or greater than 5, or greater than 10. In some embodiments, in-plane aspect ratio is in a range of 1.1 to 20, or to 100, or to 200, or to 500, or to 1000. The microstructured prismatic elements of a light redirecting layer may extend in the second direction (e.g., extend across a width of the light redirecting layer in the second direction) and may be adapted to redirect light in the first direction.

In some embodiments, the structured surface of the diffuser (which may be incorporated on the barrier elements or may be on a different layer) has a surface angle distribution having a first half width at half maximum (HWHM) in a first direction (e.g., a distribution of slopes in the x-direction, Sₓ may have a HWHM of σₓ) and a second surface angle distribution having a second HWHM in a second direction different from the first direction (e.g., a distribution of slopes in the y-direction, S_{y}, may have a HWHM of σ_{y}). In some embodiments, the first HWHM is substantially equal to the second HWHM and in some embodiments, the first HWHM is different from the second HWHM. For example, |σₓ−σ_{y}| may be in a range of about 1 degree to about 5 degrees, or to about 10 degrees, or to about 15 degrees. In some embodiments, each of σₓ and σ_{y} are in a range of about 1 degree to about 10 degrees, or to about 15 degrees. In some embodiments, the ratio of the larger of σₓ and σ_{y} to the smaller of σₓ and σ_{y} is greater than 1, or greater than 1.1, or greater than 1.2, or greater than 1.5 and is less than 20, or less than 15, or less than 10. In some embodiments, |σₓ−σ_{y}| divided by σₓ+σ_{y} is greater than 0.05, or greater than 0.1, or greater than 0.2.

Barrier Elements

One solution to form an assembly between a daylight redirecting film and a second film, such as a diffuser, involves “barrier elements,” also called “passivation islands.” In this approach a base film or liner is typically coated with a continuous layer of adhesive, for example a pressure sensitive adhesive (PSA), a hot melt, a thermoset adhesive, or a UV-curable adhesive. The adhesive layer is then printed with “barrier elements” or “islands” comprising a curable, non-tacky ink. Exposed regions of the adhesive remain tacky while the regions with the printed barrier elements are typically hard, and non-tacky. That is, the adhesive is passivated in those regions.

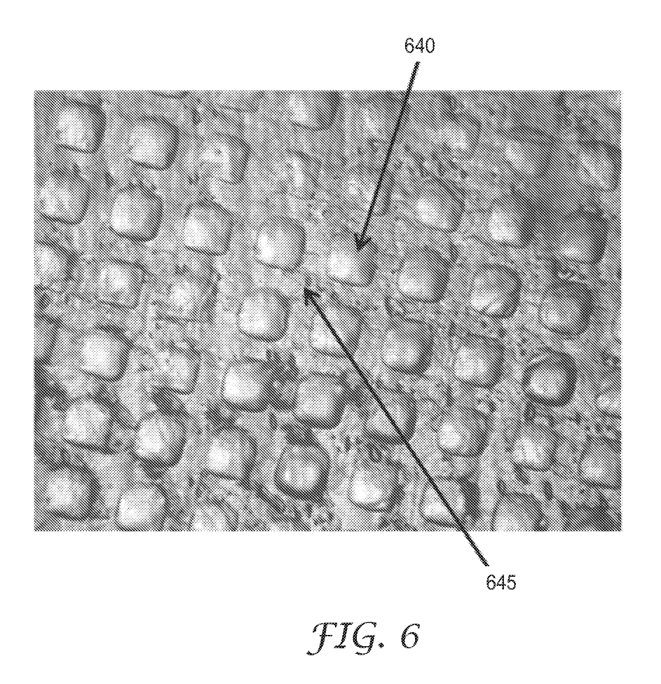

FIG. 6 shows an example in which barrier elements 640 have been printed on an adhesive 645. The square portions represent the barrier elements 640 and the channel-like areas surrounding the barrier elements are made of the non-printed adhesive. A printed barrier construction is also shown in FIG. 15 which is an image of a sample made by printing onto an adhesive as described in U.S. provisional application No. 62/065932 titled “Light Redirecting Film Constructions and Methods of Making Them” filed Oct. 20, 2014 and hereby incorporated herein by reference to the extent that it does not contradict the present disclosure.

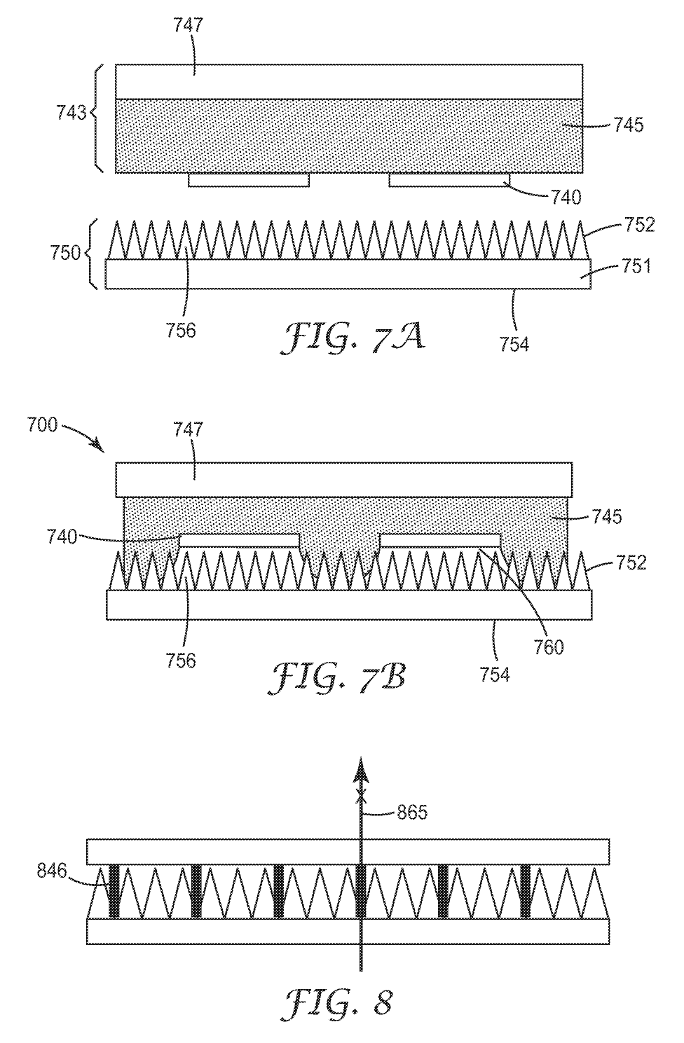

In one embodiment, the film with the printed barrier elements can be laminated to the DRF. Lamination typically occurs under heat and pressure to allow the adhesive to flow into the microstructured prismatic elements. The two films are bonded in the regions with exposed, unprinted adhesive. FIGS. 7A-7B is a schematic diagram of a typical process to bond a microstructured film to a second film. A light redirecting layer 750 having opposing first and second major surfaces 752 and 754 is provided and a film 743 including barrier elements 740 disposed on an adhesive layer 745 and including a liner 747 is provided. The light redirecting layer 750 includes microstructured prismatic elements 756 at first major surface 752. The microstructured prismatic elements 756 are disposed on substrate 751. The film 743 is laminated to the light redirecting layer 750 to form article 700 shown in FIG. 7B. Trapped air 760 is present between the barrier elements 740 and the light redirecting elements 756. Each of barrier elements 740, light redirecting elements 756, and adhesive layer 745 are typically formed from transparent materials.

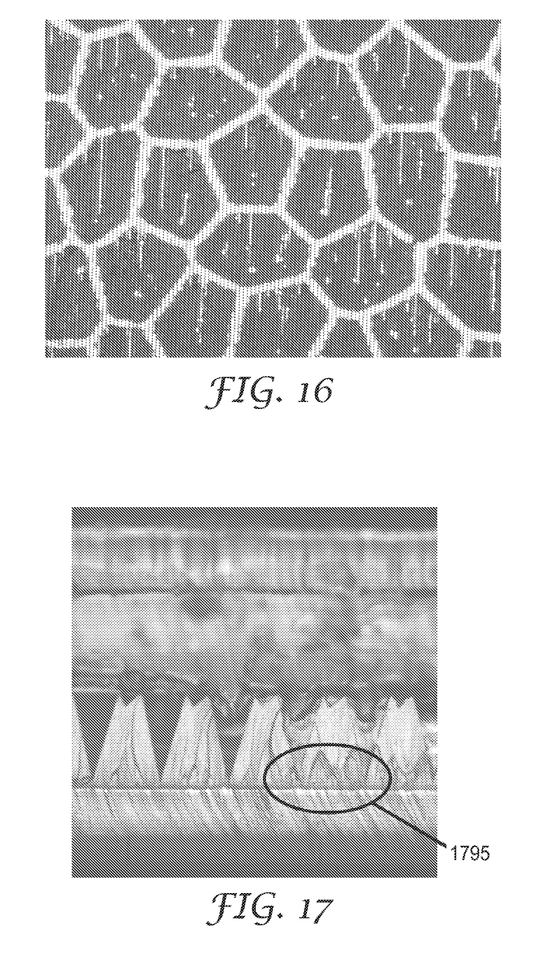

FIG. 16 is an image of a laminate, such as that in FIG. 7B, in transmission. The fine vertical lines in FIG. 16 are linear light redirecting microstructures. The darker regions are the barrier elements where the microstructures are active (i.e., able to redirect light). The lighter regions are regions where the adhesive has filled the microstructures and rendered them partially optically active, permitting transmission of light without full redirection, which is sometimes referred to as “punch through”. FIG. 17 is a cross section of the laminate, showing a region 1795 where adhesive flowed to the bottom of the microstructure.

The microstructured prismatic elements of a DRF, typically formed from resins, require an air interface to function. The barrier elements prevent the adhesive from flowing into the microstructured prismatic elements in those regions and maintain an air interface. This situation can also be seen in FIG. 7B. The microstructured prismatic elements retain their optical performance in those areas. In the bonded regions the adhesive “wets” out the microstructured prismatic elements and their optical performance (e.g., their ability to redirect light) may be degraded. Light incident on these areas may not be redirected but instead would pass right through the construction. This phenomenon is referred to as punch through. In one embodiment illustrated in FIG. 8, punch through could be eliminated if an opaque adhesive 846 is used in the areas where the adhesive is in contact with the microstructured prismatic elements 856. Light ray 865 which might have otherwise passed through the construction is blocked the opaque adhesive features 846.

The optical performance of the assembly may be optimized by maximizing the ratio of the area of barrier elements to the area of exposed adhesive. As mentioned before, the adhesion between the two substrates, measured in peel strength, is proportional to the exposed adhesive area. The required peel strength is dependent on the specific application. The peel strength and the optical performance of the assembly must be balanced when determining the area exposed to adhesive. In addition, for applications such as DRFs, the aesthetics of the pattern should also be taken into account because, not only the size of the area exposed to adhesive, but also the location of those regions within the entire film can affect how a user perceives the construction.

In certain embodiments, the peel strength for the bond between a the layer bonded to the light redirecting layer, such as a first substrate, and the light redirecting layer is from 25 g/in to 2,000 g/in (9.8 g/cm to 787 g/cm). In other embodiments, the peel strength for the bond between the first substrate and the light redirecting layer is greater than 300 g/in (118 g/cm), or greater than 400 g/in (157 g/cm), or greater than 500 g/in (199 g/cm).

In some embodiments, the barrier element diffuses visible light. As mentioned before, diffusion can be accomplished by creating surface diffusers, bulk diffusers, and embedded diffusers.

In other embodiments, the barrier elements can comprise one or more light stabilizers in order to enhance durability, for example in environments exposed to sunlight. These stabilizers can be grouped into the following categories: heat stabilizers, UV light stabilizers, and free-radical scavengers. Heat stabilizers are commercially available from Witco Corp., Greenwich, Conn. under the trade designation “Mark V 1923” and Ferro Corp., Polymer Additives Div., Walton Hills, Ohio under the trade designations

“Synpron 1163”, “Ferro 1237” and “Ferro 1720”. In some embodiments, such heat stabilizers can be present in amounts ranging from 0.02 to 0.15 weight percent. In one embodiment, UV light stabilizers can be present in amounts ranging from 0.1 to 5 weight percent. Benzophenone-type UV-absorbers are commercially available from BASF Corp., Parsippany, N.J. under the trade designation “Uvinol 400”; Cytec Industries, West Patterson, N.J. under the trade designation “Cyasorb UV1164” and Ciba Specialty Chemicals, Tarrytown, N.Y., under the trade designations “Tinuvin 900”, “Tinuvin 123” and “Tinuvin 1130”. In certain embodiments, free-radical scavengers can be present in an amount from 0.05 to 0.25 weight percent. Nonlimiting examples of free-radical scavengers include hindered amine light stabilizer (HALS) compounds, hydroxylamines, sterically hindered phenols, and the like. HALS compounds are commercially available from Ciba Specialty Chemicals under the trade designation “Tinuvin 292” and

Cytec Industries under the trade designation “Cyasorb UV3581.”

Patterns for the Barrier Elements

In certain window film applications, such as those that contemplate a DRF with a diffuser in a single construction, it may be desirable to minimize the visibility of the barrier elements. This may be achieved by judicious selection of the pattern in which the barrier elements are printed on the adhesive. Based on the inventors' experience, the following are some factors that affect pattern visibility based on considerations of the human visual system include:
Minimizing barrier elements size;
Avoiding long continuous edges or channels that have no interruptions; and
Minimizing adhesive linewidths.

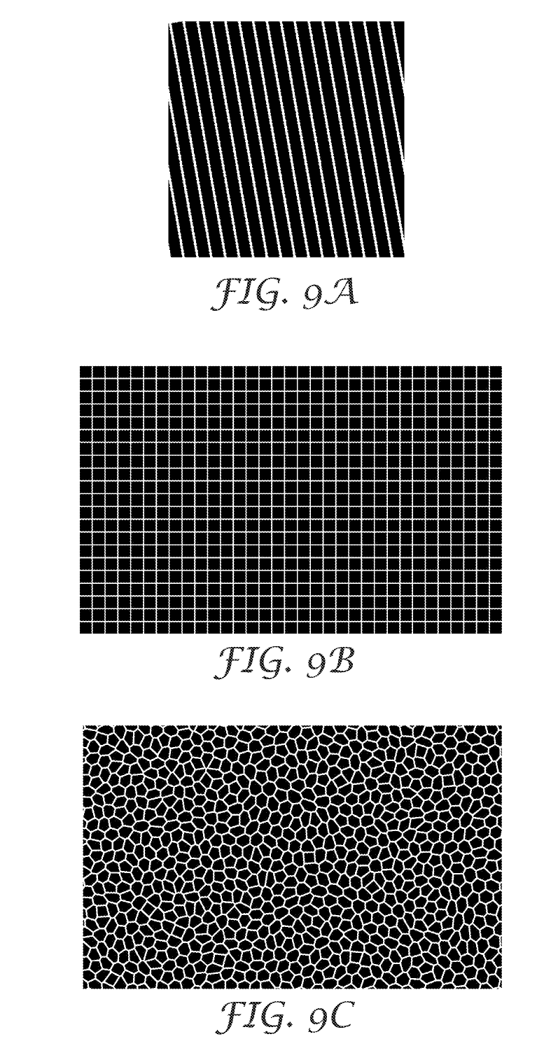

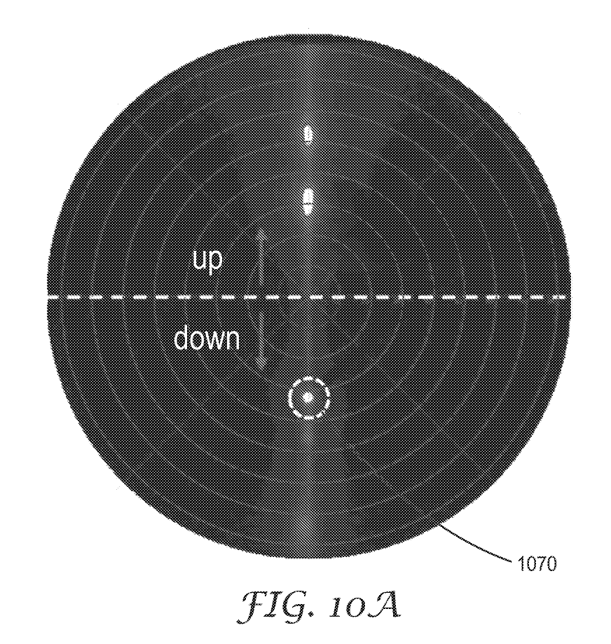

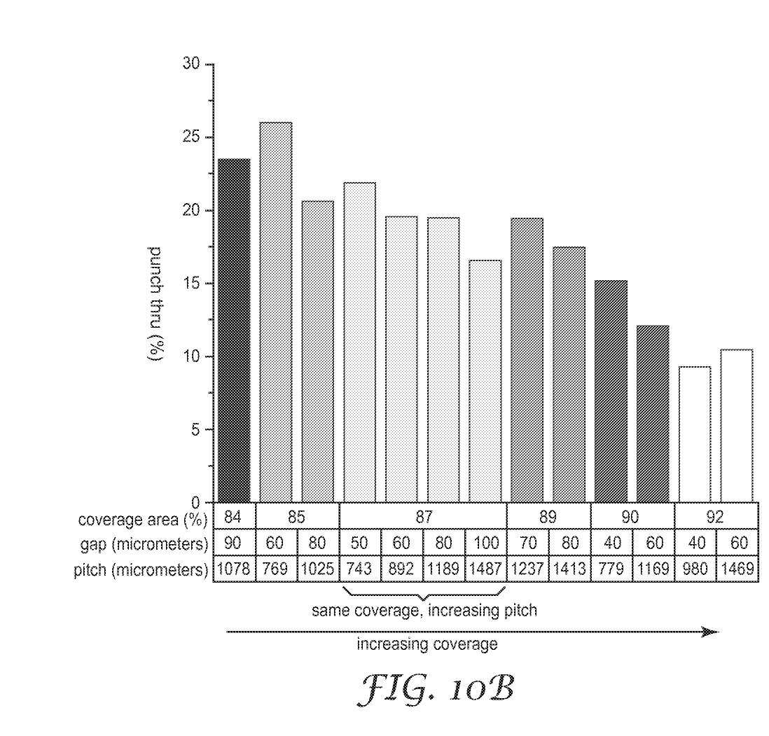

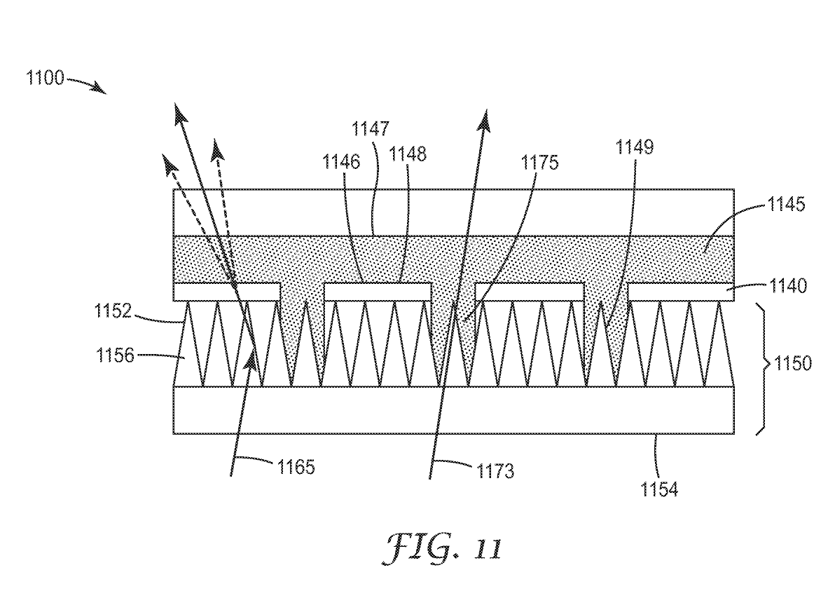

FIGS. 9A-9C show three different sample patterns. The black areas represent the barrier elements while the white areas represent the exposed adhesive. FIG. 9A represents a 1-dimensional pattern consisting of lines. The lines may be oriented in any direction. When laminated to the structured film, this construction would only be fully sealed along two edges. A full seal may still be achieved by providing an exposed adhesive border or by edge-sealing the laminate.

In general, the barrier elements can be laid out in a pattern chosen from a repeating 1-dimensional pattern, a repeating 2-dimensional pattern, and a random-looking 1- or 2-dimensional pattern.

A fully sealed construction may also be achieved by using a 2-dimensional pattern as shown in FIG. 9B. That pattern is an example of an ordered grid pattern consisting of a rectangular array of squares. FIG. 9C shows random-looking (e.g., random or pseudo-random) polygons and may be less visible to the human eye compared to the embodiment illustrated in FIG. 9B due to the breakup of the long straight edges present in FIG. 9B. The edges in the 2-dimensional patterns may be straight or have curves. Other patterns could include random or ordered arrays of dots or decorative features.

The patterns in FIGS. 9A-9C may be characterized by two independent parameters:
the pitch, which is meant to represent the center-to-center distance between corresponding barrier elements. For random-looking structures, such as those in FIG. 9C, the pitch may represent the average distance between the centers of adjacent polygons.

In certain embodiments, the average pitch in the construction is from 0.035 millimeters to 100 millimeters. In other embodiments, the average pitch in the article is from 0.1 millimeters to 10 millimeters, or from 0. 5 millimeters to 5 millimeters, or from 0.75 millimeters to 3 millimeters. In the inventors view, patterns with smaller pitches may be less visible; and
Coverage, which is understood as the ratio of the total surface area of barrier element area to the total area. The total area refers to the area defined by the microstructured prismatic elements that form the daylight redirecting film. For that reason, in this disclosure, the total surface area is also called the light redirecting area. Patterns with higher coverage may have less “punch through” while patterns with lower coverage may have higher peel strength.

In some embodiments, the total surface area of the barrier elements is greater than 50% of the light redirecting area. In other embodiments, the total surface area of the barrier elements is greater than 60%, or greater than 65%, or greater than 70%, or greater than 75%, or greater than 80%, or greater than 85%, or greater than 90%, or greater than 95%, or greater than 98%,of the light redirecting area

The gap, which represents the exposed adhesive width between barrier elements may be deduced once the pitch and coverage are known. In some embodiments, the average gap in the construction is from 0.01 millimeters to 40 millimeters. In other embodiments, the average gap in the construction is from 0.05 mm to 20 mm; or from 0.1 mm to 20 mm; or from 0.2 mm to 20 mm. For reference, both the patterns in FIG. 9A and in FIG. 9C have about 80% coverage.

The “punch through” glare from single-film DRF/diffuser constructions with random-looking polygon barrier elements having varying pitch and coverage is shown in FIGS. 10A-10B. FIG. 10A is a conoscope plot for a construction where the barrier elements cover about 92 percent of the light directing area. The sample was illuminated at 37 degrees downward. Punch through 1070 represents light that passes through the construction largely undeflected. FIG. 10B is a bar graph of punch through percentage versus coverage percentage, gap, and pitch of the barrier elements. Punch through degrades redirection performance. Higher coverage patterns result in decreased punch through and bond strength between the films in the assembly.

Pattern visibility is also determined by feature sizes: size of the barrier elements (related to pattern pitch) and gap widths. The gap visibility is determined by the gap width and the viewing distance.

Gap visibility may be estimated based on the resolution of the human visual system for a given viewing distance.

Inks for the Barrier Elements

The patterns of barrier elements may be printed by direct or offset printing using a variety of known printing methods such as flexographic printing, gravure printing, screen printing, letterpress printing, lithographic printing, ink-jet printing, digitally controlled spraying, thermal printing, and combinations thereof. For direct printing methods, barrier elements printed by flexographic printing can have thickness up to 10 micrometers, by gravure printing, thickness can be up to 30 micrometers, and by screen printing, the thickness can be up to 500 micrometers. The inks are typically printed in liquid form and then cured in place. Curing methods can include UV, E-beam, chemical, thermal curing, or cooling. Durability of the ink may be increased by additives such as light stabilizers.

In general, any material that prevents the adhesive from contacting the microstructured prismatic elements, by reducing or stopping flowing or creeping can be used as an ink for the barrier elements. Exemplary materials for use in barrier elements include resins, polymeric materials, dyes, inks, vinyl, inorganic materials, UV-curable polymers, pigments, particles, and beads.

The optical properties of the ink may also be adjusted by modifying the ink's refractive index and/or its diffusing characteristics. The diffusing properties of the ink may be modified, for example by introducing surface roughness or bulk diffusers. In some embodiments, a barrier element with diffusion is used to prepare a light redirecting construction with both clear view-through regions and light redirecting regions, such as the construction 1100 exemplified in FIG. 11.

Construction 1100 includes a light redirecting layer 1150 having opposing first and second major surfaces 1152 and 1154 where the first surface 1152 includes one or more microstructured prismatic elements 1156, adhesive layer 1145, and one or more barrier elements 1140 disposed on the adhesive layer 1145. The adhesive layer 1145 has a first major surface 1146 and a second major surface 1147. The first major surface 1146 of the adhesive layer 1145 has a first region 1148 and a second region 1149. The first region 1148 of the first surface 1146 of the adhesive layer 1145 is in contact with one or more barrier elements 1140. The second region 1149 of the first surface 1146 of the adhesive layer 1145 is in contact with one or more microstructured prismatic elements 1156. The one or more microstructured prismatic elements 1156 defines a light redirecting area, which in the illustrated embodiment is substantially the area of second major surface 1154. The total surface area of the one or more barrier elements 1140 is greater than 60% of the light redirecting area.

In the embodiment of FIG. 11, the diffuser is integrated in the barrier elements 1140. For example, the barrier elements 1140 may have a microstructured surface adapted to diffuse visible light as described elsewhere herein. Regions in which the adhesive wets out the microstructures would provide clear view through areas 1175. Light ray 1165 is incident on light redirecting layer 1150, is deflected by the microstructured prismatic elements 1156, is scattered (diffused) by the barrier elements 1140, and then exits the construction 1100. Light ray 1173 in incident on light redirecting layer 1150 near clear view through areas 1175. Light ray 1173 passes through construction 1100 with little scattering. Blurriness in the clear view areas 1175 could be reduced by matching the refractive index of the microstructured prismatic elements 1156 to the refractive index of the adhesive 1145. In certain embodiments, clear view through regions 1175 could be desirable to provide visibility past the construction.

Adhesives

In certain embodiments, the adhesives used to laminate the two films in constructions according to this disclosure, have the following characteristics:

a) the adhesive flows into the microstructured prismatic elements under suitable conditions, for example those used to laminate the two films. Suitable conditions, such as lamination, typically include heat, pressure, and, if performed in roll-to-roll operations, a certain line speed. The flow properties and thickness of the adhesive relative to the microstructured prismatic elements may be adjusted as needed. Adhesive properties that could influence flow include molecular weight, cross link density, and additives, such as plasticizers;

b) the adhesive is resistant to “creep” under the conditions used to store, apply, and use the product; and

c) the adhesive is durable under UV exposure and thermal conditions encountered. In some embodiments, UV stabilizers, such as a UV absorber (UVA) or hindered amine light stabilizer (HALS), may be added to the adhesive.

Ultraviolet absorbers function by preferentially absorbing ultraviolet radiation and dissipating it as thermal energy. Suitable UVAs may include: benzophenones (hydroxybenzophenones, e.g., Cyasorb 531 (Cytec)), benzotriazoles (hydroxyphenylbenzotriazoles, e.g., Cyasorb 5411, Tinuvin 329 (Ciba Geigy)), triazines (hydroxyphenyltriazines, e.g., Cyasorb 1164), oxanilides, (e.g., Sanuvor VSU (Clariant)) cyanoacrylates (e.g., Uvinol 3039 (BASF)), or benzoxazinones. Suitable benzophenones include, CYASORB UV-9 (2-hydroxy-4-methoxybenzophenone, CHIMASSORB 81 (or CYASORB UV 531) (2 hyroxy-4 octyloxybenzophenone). Suitable benzotriazole UVAs include compounds available from Ciba, Tarrytown, N.Y. as TINUVIN P, 213, 234, 326, 327, 328, 405 and 571, and CYASORB UV 5411 and CYASORB UV 237. Other suitable UVAs include CYASORB UV 1164 (2-[4,6-bis(2,4-dimethylphenyl)-1 ,3,5-triazin-2yl]-5(oxctyloxy) phenol (an exemplary triazine) and CYASORB 3638 (an exemplary benzoxiazine).

Hindered amine light stabilizers (HALS) are efficient stabilizers against light-induced degradation of most polymers. HALS do not generally absorb UV radiation, but act to inhibit degradation of the polymer. HALS typically include tetra alkyl piperidines, such as 2,2,6,6-tetramethyl-4-piperidinamine and 2,2,6,6-tetramethyl-4-piperidinol. Other suitable HALS include compounds available from Ciba, Tarrytown, N.Y. as TINUVIN 123, 144, and 292.

The UVAs and HALS disclosed explicitly here are intended to be examples of materials corresponding to each of these two categories of additives. The present inventors contemplate that other materials not disclosed here but known to those skilled in the art for their properties as UV absorbers or hindered amine light stabilizers can be used in the constructions of this disclosure.

In some embodiments, where it is desirable for a user to be able to see through certain regions of the construction, the refractive index of the material of the microstructured prismatic elements matches the refractive index of the adhesive layer

In certain embodiments, the adhesive in the adhesive layer is chosen from a pressure sensitive adhesive, a thermoset adhesive, hot melt adhesive, and a UV-curable adhesive.

Exemplary pressure sensitive adhesives for use in the articles of the present disclosure include crosslinked tackified acrylic pressure-sensitive adhesives. Other pressure sensitive adhesives such as blends of natural or synthetic rubber and resin, silicone or other polymer systems, with or without additives can be used. The PSTC (pressure sensitive tape council) definition of a pressure sensitive adhesive is an adhesive that is permanently tacky at room temperature, which adheres to a variety of surfaces with light pressure (finger pressure) with no phase change (liquid to solid).

Acrylic Acid and Meth(acrylic) Acid Esters: The acrylic esters are present at ranges of from about 65 to about 99 parts by weight, for example from about 78 to about 98 parts by weight, and in some embodiments from about 90 to about 98 parts by weight. Useful acrylic esters include at least one monomer selected from the group consisting of a first monofunctional acrylate or methacrylate ester of a non-tertiary alkyl alcohol, the alkyl group of which comprises from 4 to about 12 carbon atoms, and mixtures thereof. Such acrylates or methacrylate esters generally have, as homopolymers, glass transition temperatures below about −25° C. A higher amount of this monomer relative to the other comonomers affords the PSA higher tack at low temperatures.

Examples of acrylate or methacrylate ester monomers include, but are not limited to, those selected from the group consisting of n-butyl acrylate (BA), n-butyl methacrylate, isobutyl acrylate, 2-methyl butyl acrylate, 2-ethylhexyl acrilate, n-octyl acrylate, isooctyl acrylate (IOA), isooctyl methacrylate, isononyl acrylate, isodecyl acrylate, and mixtures thereof.

In some embodiments, the acrylates include those selected from the group consisting of isooctyl acrylate, n-butyl acrylate, 2-methyl butyl acrylate, 2-ethylhexyl acrylate, and mixtures thereof.

Polar Monomers: Low levels of (typically about 1 to about 10 parts by weight) of a polar monomer such as a carboxylic acid can be used to increase the cohesive strength of the pressure-sensitive adhesive. At higher levels, these polar monomers tend to diminish tack, increase glass transition temperature and decrease low temperature performance.

Useful copolymerizable acidic monomers include, but are not limited to, those selected from the group consisting of ethylenically unsaturated carboxylic acids, ethylenically unsaturated sulfonic acids, and ethylenically unsaturated phosphonic acids. Examples of such monomers include those selected from the group consisting of acrylic acid (AA), methacrylic acid, itaconic acid, fumaric acid, crotonic acid, citraconic acid, maleic acid, beta-carboxyethyl acrylate, sulfoethyl methacrylate, and the like, and mixtures thereof.

Other useful copolymerizable monomers include, but are not limited to, (meth)acrylamides, N,N-dialkyl substituted (meth)acrylamides, N-vinyl lactams, and N,N-dialkylaminoalkyl(meth)acrylates. Illustrative examples include, but are not limited to, those selected from the group consisting of N,N-dimethyl acrylamide, N,N-dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, N-vinyl pyrrolidone, N-vinyl caprolactam, and the like, and mixtures thereof.

Non-polar Ethylenically Unsaturated Monomers: The non-polar ethylenically unsaturated monomer is a monomer whose homopolymer has a solubility parameter as measured by the Fedors method (see Polymer Handbook, Bandrup and Immergut) of not greater than 10.50 and a Tg greater than 15° C. The non-polar nature of this monomer tends to improve the low energy surface adhesion of the adhesive. These non-polar ethylenically unsaturated monomers are selected from the group consisting of alkyl(meth)acrylates, N-alkyl(meth)acrylamides, and combinations thereof. Illustrative examples include, but are not limited to, 3,3,5-trimethylcyclohexyl acrylate, 3,3,5-trimethylcyclohexyl methacrylate, cyclohexyl acrylate, cyclohexyl methacrylate, isobornyl acrylate, isobornyl methacrylate, N-octyl acrylamide, N-octyl methacrylamide or combinations thereof. Optionally, from 0 to 25 parts by weight of a non-polar ethylenically unsaturated monomer may be added.

Tackifiers: In some embodiments, tackifiers are added to the adhesive and can include terpene phenolics, rosins, rosin esters, esters of hydrogenated rosins, synthetic hydrocarbon resins and combinations thereof. These provide good bonding characteristics on low energy surfaces. Hydrogenated rosin esters and hydrogenated C9 aromatic resins are useful tackifiers in some embodiments, because of performance advantages that include high levels of “tack”, outdoor durability, oxidation resistance, and limited interference in post crosslinking of acrylic PSAs.

Tackifiers may be added at a level of about 1 to about 65 parts per 100 parts of the monofunctional acrylate or methacrylate ester of a non-tertiary alkyl alcohol, the polar monomer, and the nonpolar ethylenically unsaturated monomer to achieve desired “tack”. Preferably, the tackifier has a softening point of about 65 to about 100 degrees C. However, the addition of tackifiers can reduce shear or cohesive strength and raise the Tg of the acrylic PSA, which is undesirable for cold temperature performance.

Crosslinkers: In one embodiment, crosslinkers are added to the adhesive. In order to increase the shear or cohesive strength of acrylic pressure-sensitive adhesives, a crosslinking additive may be incorporated into the PSA. Two main types of crosslinking additives are commonly used. The first crosslinking additive is a thermal crosslinking additive such as a multifunctional aziridine. One example is 1,1′-(1,3-phenylene dicarbonyl)-bis-(2-methylaziridine) (CAS No. 7652-64-4), referred to herein as “bisamide”. Such chemical crosslinkers can be added into solvent-based PSAs after polymerization and activated by heat during oven drying of the coated adhesive.

In another embodiment, chemical crosslinkers that rely upon free radicals to carry out the crosslinking reaction may be employed. Reagents such as, for example, peroxides serve as a source of free radicals. When heated sufficiently, these precursors will generate free radicals, which bring about a crosslinking reaction of the polymer. A common free radical generating reagent is benzoyl peroxide. Free radical generators are required only in small quantities, but generally require higher temperatures to complete the crosslinking reaction than those required for the bisamide reagent.

In certain embodiments, the adhesive can be a heat-activated adhesive, such as hot-melt adhesive. Heat-activated adhesives are non-tacky at room temperature but become tacky and capable of bonding to a substrate at elevated temperatures. These adhesives usually have a glass transition temperature (Tg) or melting point (Tm) above room temperature. When the temperature is increased above the Tg or Tm, the storage modulus usually decreases and the adhesive becomes tacky.

In some embodiments, the adhesive diffuses visible light. As mentioned before, diffusion can be accomplished by creating surface diffusers, bulk diffusers, and embedded diffusers.

### Daylight Redirecting Film Configurations

### Room-Facing Configurations

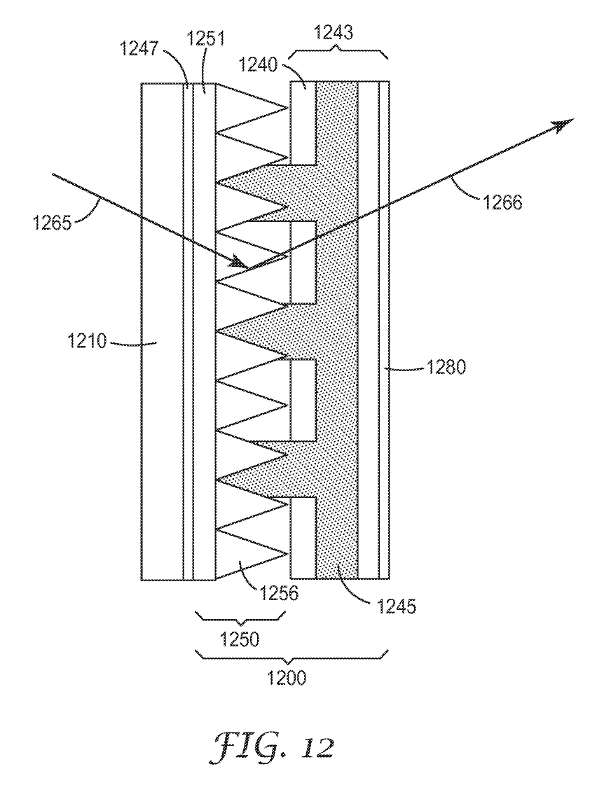

A room-facing light redirecting assembly 1200 is shown in FIG. 12. In this embodiment, a daylight redirecting film 1250 with the structures 1256, which are disposed on substrate 1251, oriented towards the room is bonded to the cover/diffusing film 1243 using the barrier elements approach. The cover film 1243 may include diffusing properties depending on the optical performance of the light redirecting microstructure. In the illustrated embodiment, the cover film 1243 includes barrier elements 1240, adhesive 1245, and diffuser 1280. Diffuser 1280 is illustrated as a layer on substrate 1251. In other embodiments, the diffuser may be integrated into substrate 1251 or may be included in or on another substrate or in or on the barrier elements 1240. The diffuser 1280 may be a surface, bulk, and/or embedded diffuser. In some embodiments, the diffuser 1280 is a surface diffuser, which may be an asymmetric or anisotropic surface diffuser as described further elsewhere herein. Diffusion may also be included in the adhesive and/or the barrier elements. The assembly 1200 may be mounted to a window or glazing 1210 using window film adhesive 1247. FIG. 12 illustrates incoming sunlight ray 1265 which is deflected by structures 1256 as it passes through the light redirecting assembly. The light ray exits the light redirecting assembly 1200 as deflected light ray 1266. Although not explicitly shown in FIG. 12, a portion of the light passing though the light redirecting assembly 1200 would typically be scattered by diffuser 1280 after being deflected by light redirecting layer 1250.

In certain embodiments, the present disclosure is directed to a film comprising an article, wherein the article comprises:

a light redirecting layer comprising a first major surface and a second major surface;

wherein the light redirecting layer comprises one or more microstructured prismatic elements on its first major surface defining a light redirecting area;

one or more barrier elements;

wherein the total surface area of the one or more barrier elements is greater than 90% of the light redirecting area;

an adhesive layer;

wherein the adhesive layer comprises a first major surface and a second major surface;

wherein the first major surface of the adhesive layer has a first region and a second region;

wherein the first region of the first surface of the adhesive layer is in contact with one or more barrier elements;

wherein the second region of the first surface of the adhesive layer is in contact with one or more microstructured prismatic elements;

a first substrate adjacent the second major surface of the adhesive layer;

wherein the first substrate comprises a diffuser having an optical haze of 20 to 85 percent, or an optical haze in any of the other ranges described elsewhere herein, and an optical clarity of no more than 50 percent, or an optical clarity in any of the other ranges described elsewhere herein; and

a window film adhesive layer adjacent the second surface of the light redirecting layer;

wherein the article allows transmission of visible light; and

wherein the film optionally further comprises a liner immediately adjacent the window film adhesive layer.

### Sun-Facing Configurations

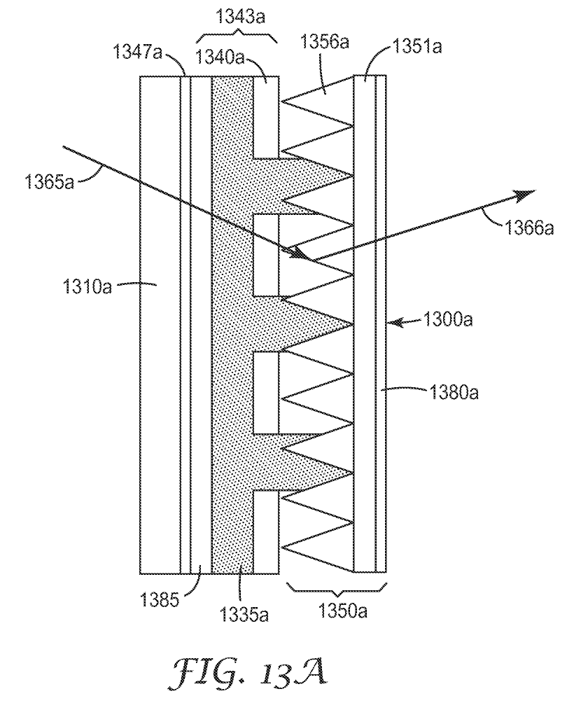

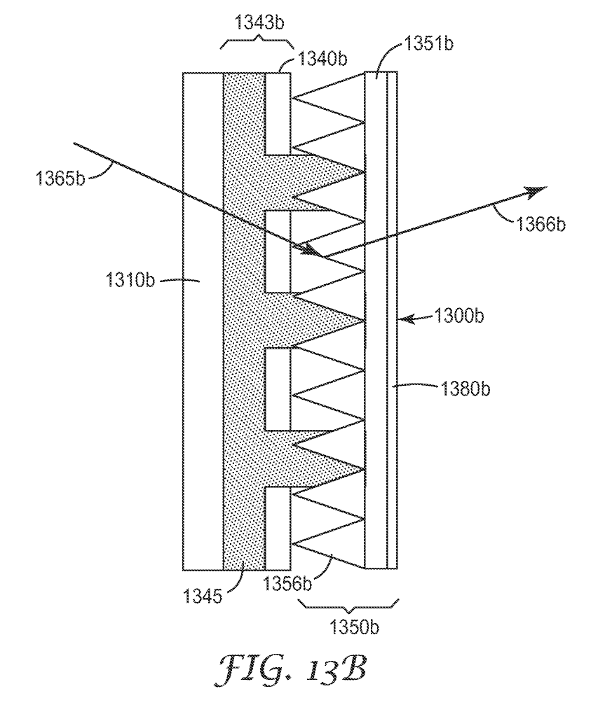

Sun-facing light redirecting configurations are shown in FIGS. 13A-13B. FIG. 13A shows assembly 1300a including light redirecting layer 1350a having light redirecting microstructures 1356a, which are disposed on substrate 1351a, and diffuser 1380a, cover film 1343a including barrier elements 1340a, adhesive 1345a, and substrate 1385. The cover film 1343a is laminated to the light redirecting layer 1350 using the barrier element approach. The assembly 1300a is attached to the window or glazing 1310a through window film adhesive 1347a. Incoming sunlight ray 1365a and outgoing redirected light ray 1366a are illustrated in FIG. 13A. Diffuser 1380a is illustrated as surface layer on substrate 1351a. In other embodiments, the diffuser may be integrated into substrate 1351a or may be included in or on another substrate or in or on the barrier elements 1340a. FIG. 13B shows assembly 1300b including light redirecting layer 1350b having light redirecting microstructures 1356b, which are disposed on substrate 1351b, and diffuser 1380b, cover film 1343b including barrier elements 1340b, and adhesive 1345b. The cover film 1343b is laminated to the light redirecting layer 1350b using the barrier element approach. The assembly 1300b is attached to the window or glazing 1310b through adhesive 1345b. Incoming sunlight ray 1365b and outgoing redirected light ray 1366b are illustrated in FIG. 13B. Diffuser 1380b is illustrated as surface layer on substrate 1351b. In other embodiments, the diffuser may be integrated into substrate 1351b or may be included in or on another substrate or in or on the barrier elements 1340b.

In both embodiments, the microstructures 1356a and 1356b are oriented towards the incoming sunlight. In these embodiments, the microstructure substrate 1351a or 1351b may also have diffusing properties integrated into it. In certain embodiments, diffusive properties can be achieved by coating a surface diffuser on the substrate side opposing the microstructured prismatic elements. This substrate could also include bulk diffusion properties. In FIG. 13A, the light redirecting substrate 1351a is bonded to a second substrate 1385 using the barrier elements approach. The substrate 1385 may have a window film adhesive 1347a coated on the opposing face to attach to a glazing 1310a.

In certain embodiments, the present disclosure is directed to a film comprising an article, wherein the article comprises:

a light redirecting layer comprising a first major surface and a second major surface;

wherein the light redirecting layer comprises one or more microstructured prismatic elements on its first major surface defining a light redirecting area;

one or more barrier elements;

wherein the total surface area of the one or more barrier elements is greater than 90% of the light redirecting area;

an adhesive layer;

wherein the adhesive layer comprises a first major surface and a second major surface;

wherein the first major surface of the adhesive layer has a first region and a second region;

wherein the first region of the first surface of the adhesive layer is in contact with one or more barrier elements;

wherein the second region of the first surface of the adhesive layer is in contact with one or more microstructured prismatic elements;

a diffuser adjacent the second major surface of the light redirecting layer;

a first substrate immediately adjacent the adhesive layer;

a window film adhesive layer immediately adjacent the first substrate;

wherein the article allows transmission of visible light;

wherein the film optionally further comprises a liner immediately adjacent the window film adhesive layer; and

wherein the diffuser has an optical haze of 20 to 85 percent, or an optical haze in any of the other ranges described elsewhere herein, and an optical clarity of no more than 50 percent, or an optical clarity in any of the other ranges described elsewhere herein.

In FIG. 13B, the second substrate 1385 is eliminated and the bonding adhesive 1345b is used both to laminate the barrier elements 1340b to the microstructured prismatic elements 1356b and to attach the assembly 1300b to the glazing 1310b. This configuration is potentially a simpler, lower cost, and thinner construction.

In certain embodiments, the present disclosure is directed to a film comprising an article, wherein the article comprises:

a light redirecting layer comprising a first major surface and a second major surface;

wherein the light redirecting layer comprises one or more microstructured prismatic elements on its first major surface defining a light redirecting area;

one or more barrier elements;

wherein the total surface area of the one or more barrier elements is greater than 90% of the light redirecting area;

an adhesive layer;

wherein the adhesive layer comprises a first major surface and a second major surface;

wherein the first major surface of the adhesive layer has a first region and a second region;

wherein the first region of the first surface of the adhesive layer is in contact with one or more barrier elements;

wherein the second region of the first surface of the adhesive layer is in contact with one or more microstructured prismatic elements;

a diffuser adjacent the second major surface of the light redirecting layer;

wherein the article allows transmission of visible light;

wherein the film optionally further comprises a liner immediately adjacent the adhesive layer; and

wherein the diffuser has an optical haze of 20 to 85 percent, or an optical haze in any of the other ranges described elsewhere herein, and an optical clarity of no more than 50 percent, or an optical clarity in any of the other ranges described elsewhere herein.

In some embodiments, the present disclosure is directed to a window comprising any of the films described above.

In certain embodiments, such as in the above room-facing and sun-facing constructions, diffusion may be incorporated in the substrates and/or adhesives. Diffusers may be surface, bulk, and/or embedded diffusers.

In some embodiments, the window film adhesive diffuses visible light. As mentioned before, diffusion can be accomplished by creating surface diffusers, bulk diffusers, and/or embedded diffusers.

In other embodiments, such as those disclosed in this section, it is useful to seal the edges of the light redirecting construction to prevent ingress of contaminants such as moisture and dirt. In those embodiments, one option to seal at least a portion of the edge is for the adhesive layer to fill the space between at least two immediately adjacent microstructured prismatic elements. In other embodiments, the entire edge can be sealed in this manner if the adhesive fills the space between the microstructured prismatic elements near the edge.

In some embodiments, the construction has a rectangular or square shape and the edge of one or more sides, up to all four sides, is sealed. In certain embodiments, the sealing can occur: by the use of a sealing agent, by the adhesive layer as described above, by using an edge sealing tape, or by using pressure, temperature, or some combination of both, including the use of a hot knife.

In other embodiments, the shape of the construction is circular or ellipsoidal shape and the edge of the construction is sealed all around. As mentioned before, the sealing can occur: by the use of a sealing agent, by the adhesive layer as described above, by using an edge sealing tape, or by using pressure, temperature, or some combination of both, including the use of a hot knife.

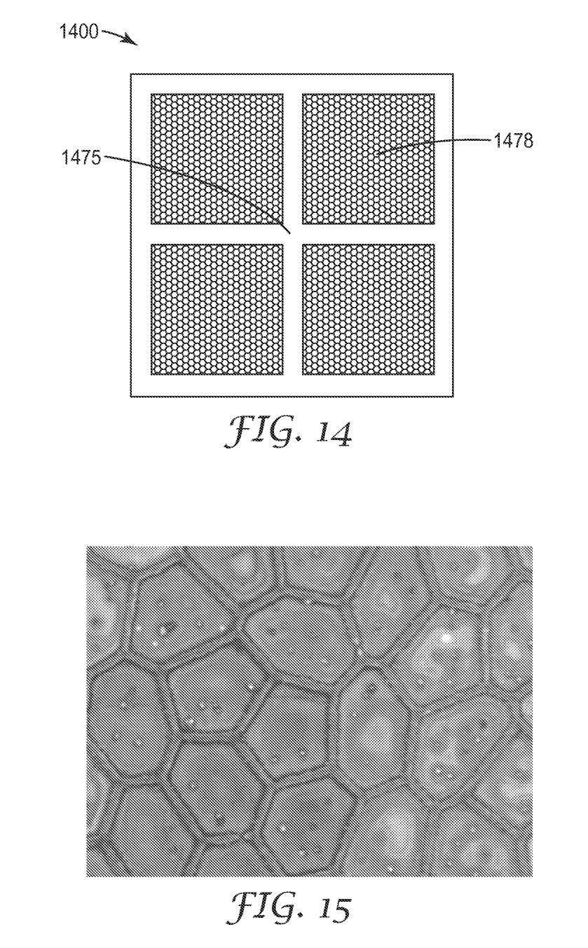

In other embodiments, the light redirecting construction can have: (a) a see-through region where the adhesive layer fills the space between adjacent microstructured prismatic elements such that no light redirecting occurs and light passes through the construction with no significant refraction, and (b) a light redirecting region as described in the embodiments disclosed above (that is, having barrier elements surrounded by the adhesive layer that bonds the light redirecting layer to a second layer or substrate). FIG. 14 shows an example of such an embodiment. In this embodiment, light redirecting construction 1400 includes see-through region 1475 and light redirecting regions 1478. In such embodiments, the barrier elements within the active light redirecting region 1478 may optionally be diffusive, for example by comprising a diffusing agent or a surface diffuser.

In yet other embodiments constructions as described in the preceding paragraph may have a diffuser (bulk, surface, or embedded) on what originally was a see-through region.

Methods of Making Daylight Redirecting Film Configurations

Another aspect of the present disclosure is directed to methods of making a light redirecting construction. In some embodiments, the method comprises:
providing a first substrate having a first major surface and a second major surface opposite the first major surface;
applying an adhesive layer to the first major surface of the first substrate;

wherein the adhesive layer has a first major surface and a second major surface opposite the first major surface; and wherein the second major surface of the adhesive layer is immediately adjacent the first major surface of the first substrate;
printing one or more barrier elements on the first major surface of the adhesive layer, and structuring a surface of at least some of the one or more barrier elements to form a diffuser comprising the structured surface;
setting the one or more barrier elements;
laminating a light redirecting layer on the first major surface of the adhesive layer;

wherein the light redirecting layer comprises one or more microstructured prismatic elements on its first major surface defining a light redirecting area;

wherein the total surface area of the one or more barrier elements is greater than 60% of the light redirecting area;

wherein the first major surface of the adhesive layer has a first region and a second region;

wherein the first region of the first surface of the adhesive layer is in contact with the one or more barrier elements;

wherein the second region of the first surface of the adhesive layer is in contact with one or more microstructured prismatic elements; and

wherein the article allows transmission of visible light and the diffuser has an optical haze of 20 to 85 percent and an optical clarity of no more than 50 percent.

In other embodiments, the printing of the one or more barrier elements can be done by direct or offset printing by processes chosen from flexographic printing, gravure printing, screen printing, letterpress printing, lithographic printing, ink-jet printing, digitally controlled spraying, thermal printing, and combinations thereof.

In yet other embodiments, setting the one or more barrier elements occurs by a method chosen from UV radiation curing, e-beam-radiation curing, thermal curing, chemical curing, and cooling.

### EXAMPLES

Microstructured Daylight Redirecting Film

A daylight redirecting film having microstructured prismatic elements formed on a polyethylene terephthalate (PET) substrate was prepared as follows.

The microstructured prismatic elements were formed with a UV-curing resin, composed of urethane acrylate oligomer (available as Photomer 6010 from BASF, Florham Park, N.J.), ethoxylated (10) bisphenol A diacrylate (available as SR602 from Sartomer Americas, Exton, Pa.), ethoxylated (4) bisphenol A diacrylate (available as SR601 from Sartomer Americas, Exton, Pa.), trimethylopropane triacrylate (available as SR351 from Sartomer Americas, Exton, Pa.), 2-phenoxyethyl acrylate (available as Etermer 210 from Toagosei America Inc., West Jefferson, Ohio), photoinitiators (available as Irgacure TPO and Darocur 1173 from BASF, Florham Park, N.J.) in a weight ratio of 60/20/4/8/8+0.35+0.1. The prismatic elements were double peaked with apex angles of 34.7 degrees and 55.7 degrees.

The substrate used was a 50 micrometer (1.97 mil) thick polyethylene terephthalate (PET) film from 3M, St Paul Minn. The free-radically curable resin was fed through a hose to a coating die, and a substantial portion of the substrate was coated with the resin composition prior to contacting the tool with the molding surface using a process as described and illustrated in FIG. 5 of U.S. Pat. No. 5,691,846. The molding surface was temperature controlled and was in the shape of a roll having the replicate of the desired pattern for the composite article. The coated substrate passed around the bottom half of the molding roll with 2 rollers positioned at 9 o'clock and 3 o'clock as the molding roll rotated in clockwise manner. The resin coated substrate first contacted the molding roll at the first nip point created by the roller at the 9 o'clock position. A coating bead was formed at this nip point to smooth any irregularities in the resin coating on the substrate. The curable composite was then cured by exposure to two sources of actinic radiation positioned to irradiate the composition as the molding surface rotated past their 5 and 7 o'clock positions. The source of the actinic radiation was ultraviolet light supplied by D lamps in a Model F600 Fusion curing system available from Fusion UV Systems Inc., Gaithersburg, Md. Each row of lamps contained two lamps positioned perpendicular to the rotational direction of the molding roll. The distance between the lamps and the molding roll was set such that the surface of the molding roll was at the focus of the lamps. Both rows of lamps were operated at 240 w/cm, and radiation passed through the substrate and into the resin composition to affect cure while the resin composition was in direct contact with the molding surface. The cured composite being a replicate of the molding surface was pulled away from the molding surface after the composite passed through the second nip point formed by the 3 o'clock roller.

The resulting daylight redirecting film is further described in Example No. 2 of U.S. provisional application No. 62/066302 titled “Sun-Facing Light Redirecting Film with Reduced Glare,” filed on Oct. 20, 2014.

Diffuser Films

A wide variety of diffuser films as listed in Table 1 were evaluated in a daylight redirecting article by lamination with the microstructured daylight redirecting film (DRF) described above. The DRF was placed on a glass window with the sun-facing microstructured prismatic elements touching the glass. The DRF was adhered to the glass using 3M SCOTCH 810 tape only around the periphery of the DRF.

A diffuser (listed in Table 1) formed separately was attached to the microstructured film opposite the microstructure. Surface diffusers were oriented with the diffusing surface facing away from the microctructured film (away from the sun). The diffuser was attached only around the periphery with 3M SCOTCH 810 tape.

The daylight redirecting article consisting of the DRF and diffuser was approximately 2-3 feet (0.6-0.9 m) in height and width. The strength of the solar column was visually characterized as described in Table 2. A characterization of “good” indicates that the solar column was spread sufficiently to eliminate the highly objectionable glare without significantly reducing the light redirected upward toward the ceiling.

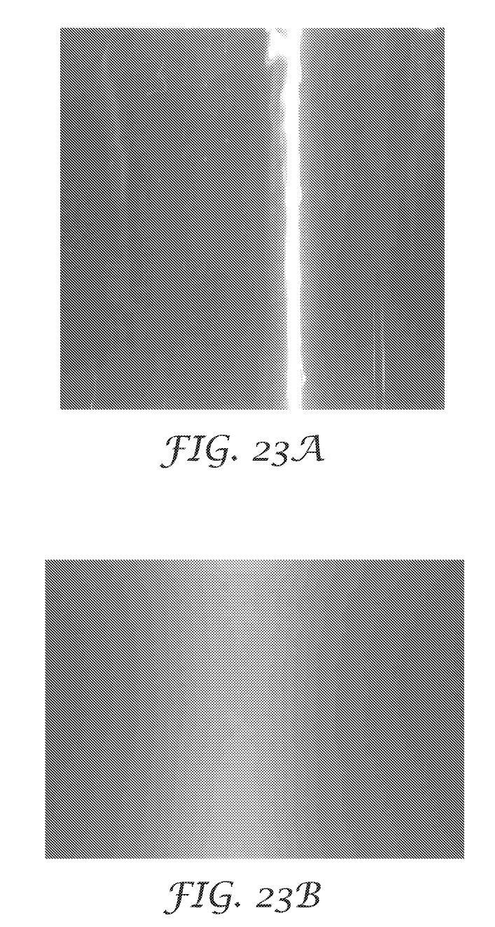

FIG. 23A shows a solar column for sunlight through the “control” which consisted of the DRF without a diffuser. FIG. 23B shows the solar column when the Surface 1 diffuser was attached to the laminate.

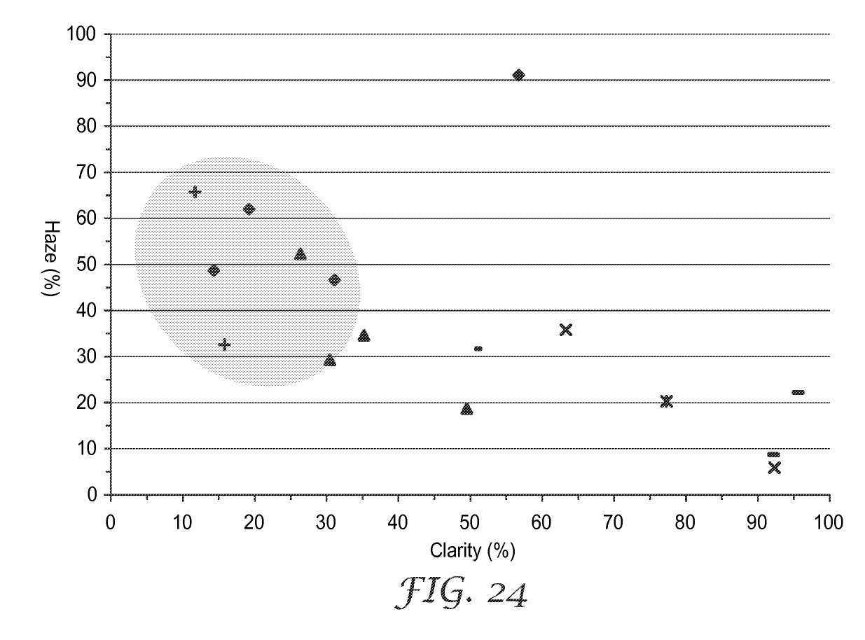

FIG. 24 shows a scatter plot of haze and clarity for various diffusers. It was found that the shaded region provided improved performance of the light redirecting article over other regions in the plot.

TABLE 1

| Abbreviation | Description | Available from: |
|---|---|---|
| FASARA 1 | FASARA Mat Crystal i | 3M Company (St. Paul, MN) |
| FASARA 2 | FASARA Mat Crystal 2 | 3M Company (St. Paul, MN) |
| FASARA 3 | FASARA Fine Crystal | 3M Company (St. Paul, MN) |
| CSD-PET | SCOTCHGARD 8995-124 | 3M Company (St. Paul, MN) |
| MARNOT 1 | MARNOT XL-20GU | Tekra, New Berlin, Wisconsin |
| MARNOT 2 | MARNOT XL-35GU | Tekra, New Berlin, Wisconsin |
| MARNOT 3 | MARNOT XL-55GU | Tekra, New Berlin, Wisconsin |
| HOSTAPHAN 1 | HOSTAPHAN ML01 | Mitsubishi Polyester Film, Inc., Greer, |
| | | South Carolina |
| HOSTAPHAN 2 | HOSTAPHAN 2262N | Mitsubishi Polyester Film, Inc., Greer, |
| | | South Carolina |
| SKYROL | SKYROL SR50-200ga | SKC Inc., Covington, Georgia |
| MYLAR 1 | MYLAR A/200 | DuPont Teijin Films, Chester, Virginia |
| MYLAR 2 | MYLAR S/200 | DuPont Teijin Films, Chester, Virginia |
| LUMIRROR | LUMIRROR 92GFA5L | Toray Plastics (America), Inc., North |
| | | Kingstown, Rhode Island |
| QUESTAR | QUESTAR AI-316 | Filmquest Group Inc., Bolingbrook, |
| | | Illinois |
| Surface 1 | Surface diffuser having a | Made as generally described in U.S. Pat. |
| | haze of 32.6 percent and a | Nos. 8,657,472 (Aronson et al.) |
| | clarity of 15.8 percent. | |
| Surface 2 | Surface diffuser having a | Made as generally described in U.S. Pat. |
| | haze of 65.7 percent and a | Nos. 8,657,472 (Aronson et al.) |
| | clarity of 11.7 percent. The | |
| | standard deviation of the | |
| | slope magnitude along a | |
| | first direction was 4.9 | |
| | degrees and was 10.7 | |
| | degrees along the | |
| | orthogonal direction. | |

TABLE 2

| | Transmission | Haze | Clarity | |
|---|---|---|---|---|
| Diffuser | (%) | (%) | (%) | Solar Column |
| Control (no diffuser) | — | — | — | Very bright solar |
| | | | | column |
| FASARA 1 | 89.8 | 62 | 19.2 | good |
| FASARA 2 | 90.4 | 48.7 | 14.3 | good |
| FASARA 3 | 89.8 | 46.6 | 31.1 | good, slight column |
| | | | | visible |
| CSD-PET | 93.4 | 29.3 | 30.5 | good, slight column |
| | | | | visible |
| MARNOT 1 | 91.9 | 52.3 | 26.4 | good |
| MARNOT 2 | 92.3 | 34.6 | 35.2 | good, slight column |
| MARNOT 3 | 92.5 | 18.7 | 49.5 | diffuse column |
| HOSTAPHAN 1 | 89.2 | 35.8 | 63.3 | bright column |
| HOSTAPHAN 2 | 90.4 | 5.91 | 92.3 | strong column |
| SKYROL | 89.4 | 20.3 | 77.3 | strong column |
| MYLAR 1 | 88 | 22.2 | 95.6 | strong column |
| MYLAR 2 | 89.5 | 8.7 | 92.2 | strong column |
| LUMIRROR | 90.2 | 31.7 | 50.8 | thin orange column |
| QUESTAR | 88.3 | 91.1 | 56.7 | thin orange column |
| Surface 1 | 94.4 | 32.6 | 15.8 | good |
| Surface 2 | 94.7 | 65.7 | 11.7 | good, slight color |

Adhesive Transfer Tape Suitable for use with Barrier Elements

Adhesive transfer tape was made by solution coating a pressure sensitive adhesive (PSA) composition. The PSA composition was formed by mixing 90 parts by weight isooctyl acrylate (IOA) and 10 parts by weight acrylic acid (AA) and then mixing with 0.1% of a bisamide cross-linker. After coating and solvent removal, the adhesive layer thickness was approximately 75 micrometers (3 mil).

Barrier Element Formulation

The printed barrier elements were made from an acrylate formulation containing 50 wt % Ebecryl 8301-R (Allnex, Smyrna, GA), 25 wt % 1,6-hexanediol diacrylate (Ciba/BASF, Hawthorne, N.Y.), and 25 wt % pentaerythritol tetraacrylate (Sigma-Aldrich, St. Louis, MO). One weight percent PL-100 photoinitiator was added based on the total weight of the monomers. PL-100 is a 70:30 blend of oligo [2-hydroxy-2-methyl-1-[4-(1-methylvinyl) phenyl] propanone] and 2-hydroxy-2-methyl-1-phenyl-1-propanone that is commercially available from Esstech, Inc., Essington, Pa. These components were combined to provide a uniform mixture.

Barrier Elements Printed on Adhesive Transfer Tape

A flexographic printing plate comprising a predetermined print pattern based on preselected images was used. The print pattern was a random-looking pattern having pitch 1169 micrometers, gap 135 micrometers, and designed coverage 78%. Pitch refers to the center-to-center distance between barrier elements, gap refers to the distance between adjacent barrier elements, and designed coverage refers to the percentage of the total area covered by the barrier elements. The flexographic printing plate measured approximately 30.5×30.5 cm and was manually wiped with isopropanol before printing.

The barrier element formulation was then printed onto the adhesive using a flexographic printing process. The flexographic printing plate was mounted on a smooth roll of a flexographic printing apparatus using 1060 Cushion-Mount flexographic plate mounting tape (3M Company, St. Paul, Minn.). The barrier element formulation was introduced into the flexographic printing apparatus using conventional methods and equipment and was transferred onto the printing surfaces of the flexographic printing plate via an anilox roll. The printable composition was then transferred to the adhesive film at a line speed of approximately 3 meters per minute. The coated adhesive film then passed through a Maxwell UV curing apparatus (available from XericWeb, Neenah, Wis.) that was in-line with the printing apparatus. The UV curing apparatus was operated at full power with nitrogen gas inerting. The printed barrier element construction is shown in FIG. 15, and has been stained to enhance the contrast between the barrier elements and the gaps.

Laminate Comprising Printed Adhesive Transfer Tape and a Daylight Redirecting Film

The adhesive transfer tape printed with barrier elements was then laminated to a microstructured daylight redirecting microstructured film as describe above under heat (190° F. (88° C.)) and pressure (40 psi (276 kPa)) at a line speed of 15 feet per minute (4.6 meters per minute). FIG. 16 is an image of the laminate in transmission. The fine vertical lines in FIG. 16 are the linear light redirecting microstructures. The darker regions are the barrier elements where the microstructures are active (i.e., able to redirect light). The lighter regions are regions where the adhesive has filled the microstructures and rendered them partially optically active, permitting transmission of light without full redirection, which is sometimes referred to as “punch through”. FIG. 17 is a cross section of the laminate, showing that adhesive can flow to the bottom of the microstructure.

Under these lamination conditions the adhesive flows all the way down to the bottom of the valleys between the microstructures, as shown in FIG. 17. This flow of adhesive to the bottom of the valleys of the microstructures combined with the two dimensional interconnected adhesive pattern fully seals the laminate from contaminants such as water.

Immersion Testing and Optical Performance

A demonstration that the interconnected adhesive pattern fully sealed the laminate was shown by immersing and removing the above assembly in water without loss of optical performance.

The optical performance of this laminate was characterized using an IS-SA-13-1 Imaging Sphere from Radiant-Zemax (Redmond, Wash.). The sample was illuminated at 37 degree elevation using a metal halide light source and the angular profile of the transmitted light was measured.

FIG. 10A is a conoscopic plot of a construction having barrier elements with a designed coverage of about 78%. Light redirected upwards can be seen in the upper quadrants. The “punch through” going downwards is circled in the lower quadrants. Punch through represents light that traverses the optical construction largely undeviated. Punch through may result in glare depending on the solar elevation.

The light redirection performance can be quantified by the UpRatio which defined as:

$$UpRatio = \frac{Up}{Up + Down} ;$$

In this UpRatio, Up refers to the fraction of light that is redirected upward and Down refers to the fraction of the light that is redirected downward. For this sample and at this elevation angle the UpRatio was approximately 73%.

Diffusers and Daylight Redirecting Articles Including the Diffusers

A number of laminates that included the printed adhesive transfer tape and daylight redirecting film as described above were formed with a diffuser coated onto to the PET substrate of the daylight redirecting film opposite the light redirecting elements. The resulting daylight redirecting articles had the basic structure as illustrated in FIG. 13A and the diffusers evaluated were the MARNOT 1, Surface 1 and Surface 2 diffusers listed in Table 1. These surface diffusers were oriented with the diffusing surface facing away from the light redirecting elements.

The daylight redirecting articles were attached to a window facing the sun as shown in FIG. 13A and the strength of the solar column was characterized as described in Table 3. A characterization of “good” indicates that the solar column was spread sufficiently to eliminate the highly objectionable glare without significantly reducing the light redirected upward toward the ceiling.

TABLE 3

| | Transmission | | | |
|---|---|---|---|---|
| Diffuser | (%) | Haze (%) | Clarity (%) | Solar Column |
| MARNOT 1 | 91.9 | 52.3 | 26.4 | good |
| Surface 1 | 94.4 | 32.6 | 15.8 | good |
| Surface 2 | 94.7 | 65.7 | 11.7 | good, slight color |

The following is a list of exemplary embodiments of the present description.
Embodiment 1 is an article comprising:
a light redirecting layer comprising a first major surface and a second major surface;
one or more barrier elements;
an adhesive layer;
wherein the light redirecting layer comprises one or more microstructured prismatic elements on its first major surface defining a light redirecting area;
wherein the total surface area of the one or more barrier elements is greater than 60% of the light redirecting area;
wherein the adhesive layer comprises a first major surface and a second major surface;
wherein the first major surface of the adhesive layer has a first region and a second region;
wherein the first region of the first surface of the adhesive layer is in contact with one or more barrier elements;
wherein the second region of the first surface of the adhesive layer is in contact with one or more microstructured prismatic elements;
wherein the article allows transmission of visible light; and
wherein either at least one of the one or more barrier elements or an optional diffuser disposed adjacent the light redirecting layer or adjacent the adhesive layer has an optical haze of 20 to 85 percent and an optical clarity of no more than 50 percent.
Embodiment 2 is the article of embodiment 1, wherein the optical haze is in a range of 20 to 75 percent and the optical clarity is in a range of 5 to 40 percent.
Embodiment 3 is the article of embodiment 1, wherein the optical haze is in a range of 25 to 65 percent and the optical clarity is in a range of 7 to 37 percent.
Embodiment 4 is the article of embodiment 1, wherein the optical haze is in a range of 30 to 60 percent and the optical clarity is in a range of 10 to 35 percent.
Embodiment 5 is the article of any of the previous embodiments, wherein the at least one of the one or more barrier elements has a structured surface adapted to diffuse visible light.
Embodiment 6 is the article of any of the previous embodiments, wherein the article includes the optional diffuser and the optional diffuser has a structured surface adapted to diffuse visible light.
Embodiment 7 is the article of embodiment 6, wherein the optional diffuser is immediately adjacent the light redirecting layer.
Embodiment 8 is the article of any of embodiments 5 to 7, wherein the structured surface comprises asymmetric light diffusing surface structures.
Embodiment 9 is the article of embodiment 8, wherein the structured surface has a surface angle distribution having a first half width at half maximum (HWHM) in a first direction and a second surface angle distribution having a second HWHM in a second direction different from the first direction, wherein the first HWHM is different from the second HWHM.
Embodiment 10 is the article of embodiment 9, wherein a ratio of the first HWHM to the second HWHM is greater than 1.1.
Embodiment 11 is the article of any of embodiments 5 to 10, wherein the structured surface is more diffusive along a first direction and less diffusive along a second direction orthogonal to the first direction.
Embodiment 12 is the article of embodiment 11, where the microstructured prismatic elements extend in the first direction.
Embodiment 13 is the article of any of embodiments 5 to 12, wherein the structured surface comprises lenticular structures.
Embodiment 14 is the article of any of embodiments 5 to 12, wherein the structured surface comprises approximately semi-ellipsoidal or approximately semi-biconic structures.
Embodiment 15 is the article of any of embodiments 5 to 14, wherein the structured surface comprises randomly or pseudo-randomly distributed structures.
Embodiment 16 is the article of any of embodiments 5 to 15, wherein at least 80 percent of the structured surface has a slope magnitude greater than about 1 degree.
Embodiment 17 is the article of any of embodiments 5 to 16, wherein at least 90 percent of the structured surface has a slope magnitude greater than about 1 degree.
Embodiment 18 is the article of any of embodiments 5 to 17, wherein less than 2 percent of the structured surface has a slope magnitude less than 1 degree.
Embodiment 19 is an article according to embodiment any of the preceding embodiments, wherein the light redirecting layer comprises a light redirecting substrate, and wherein the one or more microstructured prismatic elements are on the light redirecting substrate.
Embodiment 20 is an article according to any of the preceding embodiments, wherein the total surface area of the one or more barrier elements is greater than 65% of the light redirecting area.
Embodiment 21 is an article according to any of the preceding embodiments, wherein the total surface area of the one or more barrier elements is greater than 70% of the light redirecting area.
Embodiment 22 is an article according to any of the preceding embodiments, wherein the total surface area of the one or more barrier elements is greater than 80% of the light redirecting area.
Embodiment 23 is an article according to any of the preceding embodiments, wherein the total surface area of the one or more barrier elements is greater than 90% of the light redirecting area.
Embodiment 24 is an article according to any of the preceding embodiments, wherein the total surface area of the one or more barrier elements is greater than 95% of the light redirecting area.
Embodiment 25 is an article according to any of the preceding embodiments, wherein the total surface area of the one or more barrier elements is greater than 98% of the light redirecting area.
Embodiment 26 is an article according to any of the preceding embodiments, wherein a barrier element diffuses visible light.
Embodiment 27 is an article according to any of the preceding embodiments, wherein a barrier element comprises a diffusing agent.
Embodiment 28 is an article according to any of the preceding embodiments, wherein a barrier element comprises particles as a diffusing agent
Embodiment 29 is an article according to any of the preceding embodiments, wherein the adhesive layer comprises a diffusing agent.
Embodiment 30 is an article according to any of the preceding embodiments, wherein the adhesive layer comprises particles as a diffusing agent.
Embodiment 31 is an article according to any of the preceding embodiments, wherein the window film adhesive layer comprises a diffusing agent.
Embodiment 32 is an article according to any of the preceding embodiments, wherein the window film adhesive layer comprises particles as a diffusing agent.
Embodiment 33 is an article according to any of the preceding embodiments, wherein the surface roughness of a barrier element provides visible-light diffusing properties to the barrier element.
Embodiment 34 is an article according to any of the preceding embodiments, wherein a barrier element comprises one or more light stabilizers.
Embodiment 35 is an article according to any of the preceding embodiments, wherein the material of the barrier elements has been cured using UV radiation or heat.
Embodiment 36 is an article according to any of the preceding embodiments, wherein the barrier elements are laid out in a pattern chosen from a repeating 1-dimensional pattern, a repeating 2-dimensional pattern, and a random-looking 1- or 2-dimensional pattern.
Embodiment 37 is an article according to any of the preceding embodiments, wherein the center-to-center distance between barrier elements defines the pitch; and wherein the average pitch in the article is from 0.035 millimeters to 100 millimeters.
Embodiment 38 is an article according to any of the preceding embodiments, wherein the center-to-center distance between barrier elements defines the pitch; and wherein the average pitch in the article is from 0.1 millimeters to 10 millimeters.
Embodiment 39 is an article according to any of the preceding embodiments, wherein the center-to-center distance between barrier elements defines the pitch; and wherein the average pitch in the article is from 0. 5 millimeters to 5 millimeters.
Embodiment 40 is an article according to any of the preceding embodiments, wherein the center-to-center distance between barrier elements defines the pitch; and wherein the average pitch in the article is from 0.75 millimeters to 3 millimeters.
Embodiment 41 is an article according to any of the preceding embodiments, wherein the width of a channel of the second region of the first surface of the adhesive layer defines a gap; and wherein the average gap in the article is from 0.01 millimeters to 40 millimeters.
Embodiment 42 is an article according to any of the preceding embodiments, wherein the adhesive in the adhesive layer is chosen from a pressure sensitive adhesive, a thermoset adhesive, hot melt adhesive, and a UV curable adhesive.
Embodiment 43 is an article according to any of the preceding embodiments, wherein the adhesive in the adhesive layer is a pressure sensitive adhesive.
Embodiment 44 is an article according to any of the preceding embodiments, wherein the adhesive layer comprises one or more UV stabilizers.
Embodiment 45 is an article according to any of the preceding embodiments, wherein the refractive index of the material of the microstructured prismatic elements matches the refractive index of the adhesive layer.
Embodiment 46 is an article according to any of the preceding embodiments, further comprising a first substrate adjacent the second major surface of the adhesive layer.
Embodiment 47 is an article according to any of the preceding embodiments, wherein the peel strength for the bond between the first substrate and the light redirecting layer is from 25 g/in to 2,000 g/in.
Embodiment 48 is an article according to any of the preceding embodiments, wherein the peel strength for the bond between the first substrate and the light redirecting layer is greater than 300 g/in.
Embodiment 49 is an article according to any of the preceding embodiments, wherein the peel strength for the bond between the first substrate and the light redirecting layer is greater than 400 g/in.
Embodiment 50 is an article according to any of the preceding embodiments, wherein the peel strength for the bond between the first substrate and the light redirecting layer is greater than 500 g/in.
Embodiment 51 is an article according to any of the preceding embodiments, wherein the second region of the first major surface of the adhesive layer fills the space between at least two immediately adjacent microstructured prismatic elements.
Embodiment 52 is an article according to any of the preceding embodiments, wherein the article has a rectangular or square shape and the edge of all four sides is sealed.
Embodiment 53 is an article according to any of the preceding embodiments, wherein the article has a rectangular or square shape and the edge of at least one side is sealed by the adhesive layer.
Embodiment 54 is an article according to any of the preceding embodiments, wherein the article has a rectangular or square shape and the edge of at least one side is sealed with a sealing agent.
Embodiment 55 is an article according to any of the preceding embodiments, wherein the article has a rectangular or square shape and the edge of at least one side is sealed with an edge sealing tape.
Embodiment 56 is an article according to any of the preceding embodiments, wherein the article has a rectangular or square shape and the edge of at least one side is sealed using pressure, temperature, or a combination of both pressure and temperature.
Embodiment 57 is an article according to any of the preceding embodiments, wherein the article has a circular or ellipsoidal shape and the edge of the article is sealed all around.
Embodiment 58 is an article according to any of the preceding embodiments, wherein the article has a circular or ellipsoidal shape and at least a portion of the edge of the article is sealed by the adhesive layer.
Embodiment 59 is an article according to any of the preceding embodiments, wherein the article has a circular or ellipsoidal shape and at least a portion of the edge of the article is sealed with a sealing agent.
Embodiment 60 is an article according to any of the preceding embodiments, wherein the article has a circular or ellipsoidal shape and at least a portion of the edge of the article is sealed with an edge sealing tape.
Embodiment 61 is an article according to any of the preceding embodiments, wherein the article has a circular or ellipsoidal shape and at least a portion of the edge of the article is sealed using pressure, temperature, or a combination of both pressure and temperature.
Embodiment 62 is a film comprising an article according to any of the preceding embodiments, wherein the article further comprises a second substrate adjacent the second major surface of the adhesive layer;
wherein the article further comprises a window film adhesive layer adjacent the second major surface of the light redirecting layer; and
wherein the article optionally further comprises a liner adjacent the window film adhesive layer.
Embodiment 63 is a film according to embodiment 62, further comprising the optional diffuser adjacent the second substrate.
Embodiment 64 is a film according to embodiment 62, further wherein the second substrate comprises the optional diffuser.
Embodiment 65 is a window comprising a film as embodimented as in any of the preceding embodiments directed to a film, wherein the window further comprises a glazing immediately adjacent the window film adhesive layer.
Embodiment 66 is a film comprising an article according to any of the preceding embodiments directed to an article,
wherein the article further comprises a second substrate adjacent the second major surface of the light redirecting layer;
wherein the article optionally further comprises a liner adjacent the adhesive layer.
Embodiment 67 is a film according to embodiment 66, further comprising the optional diffuser adjacent the second substrate.
Embodiment 68 is a film according to embodiment 66, further wherein the second substrate comprises the optional diffuser.
Embodiment 69 is a window comprising a film as in any of embodiments 66 to 68, wherein the window further comprises a glazing immediately adjacent the adhesive layer.
Embodiment 70 is a film comprising an article according to any of the preceding embodiments directed to an article, wherein the article further comprises:
   a second substrate adjacent the second major surface of the light redirecting layer
   a third substrate immediately adjacent the adhesive layer;
   a window film adhesive layer immediately adjacent the third substrate; and
   optionally a liner adjacent the window film adhesive layer.
Embodiment 71 is a film according to embodiment 70, further comprising the optional diffuser adjacent the second substrate.
Embodiment 72 is a film according to embodiment 70, further wherein the second substrate comprises the optional diffuser.
Embodiment 73 is a window comprising a film as embodimented as in any of embodiments 70 to 72,
wherein the window further comprises a glazing immediately adjacent the window film adhesive layer.
Embodiment 74 is a film according to any of the preceding embodiments directed to films that comprise a diffuser, wherein the diffuser is chosen from bulk diffusers, surface diffusers, and embedded diffusers or combinations thereof.
Embodiment 75 is a window according to any of the preceding embodiments directed to windows that comprise a diffuser, wherein the diffuser is chosen from bulk diffusers, surface diffusers, and embedded diffusers or combinations thereof.
Embodiment 76 is a film comprising an article,
wherein the article comprises:
a light redirecting layer comprising a first major surface and a second major surface;
wherein the light redirecting layer comprises one or more microstructured prismatic elements on its first major surface defining a light redirecting area;
one or more barrier elements;
wherein the total surface area of the one or more barrier elements is greater than 90% of the light redirecting area;
an adhesive layer;
wherein the adhesive layer comprises a first major surface and a second major surface;
wherein the first major surface of the adhesive layer has a first region and a second region;
wherein the first region of the first surface of the adhesive layer is in contact with one or more barrier elements;
wherein the second region of the first surface of the adhesive layer is in contact with one or more microstructured prismatic elements;
a first substrate adjacent the second major surface of the adhesive layer;
wherein the first substrate comprises a diffuser having an optical haze of 20 to 85 percent and an optical clarity of no more than 50 percent; and
a window film adhesive layer adjacent the second surface of the light redirecting layer;
wherein the article allows transmission of visible light;
wherein the film optionally further comprises a liner immediately adjacent the window film adhesive layer.
Embodiment 77 is a film comprising an article,
wherein the article comprises:
a light redirecting layer comprising a first major surface and a second major surface;
wherein the light redirecting layer comprises one or more microstructured prismatic elements on its first major surface defining a light redirecting area;
one or more barrier elements;
wherein the total surface area of the one or more barrier elements is greater than 90% of the light redirecting area;
an adhesive layer;
wherein the adhesive layer comprises a first major surface and a second major surface;
wherein the first major surface of the adhesive layer has a first region and a second region;
wherein the first region of the first surface of the adhesive layer is in contact with one or more barrier elements;
wherein the second region of the first surface of the adhesive layer is in contact with one or more microstructured prismatic elements;
a diffuser adjacent the second major surface of the light redirecting layer;
a first substrate immediately adjacent the adhesive layer;
a window film adhesive layer immediately adjacent the first substrate;
wherein the article allows transmission of visible light;
wherein the film optionally further comprises a liner immediately adjacent the window film adhesive layer,
wherein the diffuser has an optical haze of 20 to 85 percent and an optical clarity of no more than 50 percent.
Embodiment 78 is a film comprising an article,
wherein the article comprises:
a light redirecting layer comprising a first major surface and a second major surface;
wherein the light redirecting layer comprises one or more microstructured prismatic elements on its first major surface defining a light redirecting area;
one or more barrier elements;
wherein the total surface area of the one or more barrier elements is greater than 90% of the light redirecting area;
an adhesive layer;
wherein the adhesive layer comprises a first major surface and a second major surface;
wherein the first major surface of the adhesive layer has a first region and a second region;
wherein the first region of the first surface of the adhesive layer is in contact with one or more barrier elements;
wherein the second region of the first surface of the adhesive layer is in contact with one or more microstructured prismatic elements;
a diffuser adjacent the second major surface of the light redirecting layer;
wherein the article allows transmission of visible light;
wherein the film optionally further comprises a liner immediately adjacent the adhesive layer;
wherein the diffuser has an optical haze of 20 to 85 percent and an optical clarity of no more than 50 percent.
Embodiment 79 is the film of any of embodiments 76 to 78, wherein the optical haze is in a range of 20 to 75 percent and the optical clarity is in a range of 5 to 40 percent.
Embodiment 80 is the film of any of embodiments 76 to 78, wherein the optical haze is in a range of 25 to 65 percent and the optical clarity is in a range of 7 to 37 percent.
Embodiment 81 is the film of any of embodiments 76 to 78, wherein the optical haze is in a range of 30 to 60 percent and the optical clarity is in a range of 10 to 35 percent.
Embodiment 82 is the film of any of embodiments 76 to 81, wherein the diffuser has a structured surface adapted to diffuse visible light.
Embodiment 83 is the film of embodiment 82, wherein the structured surface comprises asymmetric light diffusing surface structures.
Embodiment 84 is the article of embodiment 83, wherein the structured surface has a surface angle distribution having a first half width at half maximum (HWHM) in a first direction and a second surface angle distribution having a second HWHM in a second direction different from the first direction, wherein the first HWHM is different from the second HWHM.
Embodiment 85 is the film of embodiment 84, wherein a ratio of the first HWHM to the second HWHM is greater than 1.1.
Embodiment 86 is the film of any of embodiments 82 to 85, wherein the structured surface is more diffusive along a first direction and less diffusive along a second direction orthogonal to the first direction.
Embodiment 87 is the film of embodiment 86, where the microstructured prismatic elements extend in the first direction.
Embodiment 88 is the film of any of embodiments 82 to 87, wherein the structured surface comprises lenticular structures.
Embodiment 89 is the film of any of embodiments 82 to 88, wherein the structured surface comprises approximately semi-ellipsoidal or approximately semi-biconic structures.
Embodiment 90 is the film of any of embodiments 82 to 89, wherein the structured surface comprises randomly or pseudo-randomly distributed structures.
Embodiment 91 is the film of any of embodiments 82 to 90, wherein at least 80 percent of the structured surface has a slope magnitude greater than about 1 degree.
Embodiment 92 is the film of any of embodiments 82 to 91, wherein at least 90 percent of the structured surface has a slope magnitude greater than about 1 degree.
Embodiment 93 is the film of any of embodiments 82 to 92, wherein less than 2 percent of the structured surface has a slope magnitude less than 1 degree.
Embodiment 94 is an article comprising:
a light redirecting layer comprising a first major surface and a second major surface;
one or more barrier elements;
an adhesive layer;
wherein the light redirecting layer comprises one or more microstructured prismatic elements on its first major surface defining a light redirecting area;
wherein the total surface area of the one or more barrier elements in at least a portion of the article defined as a light redirecting region is greater than 60% of the light redirecting area;
wherein the adhesive layer comprises a first major surface and a second major surface;
wherein the first major surface of the adhesive layer has a first region and a second region;
wherein the first region of the first surface of the adhesive layer is in contact with one or more barrier elements;

wherein the second region of the first surface of the adhesive layer is in contact with one or more microstructured prismatic elements;
wherein the article allows transmission of visible light;
wherein the one or more barrier elements comprises a diffuser having an optical haze of 20 to 85 percent and an optical clarity of no more than 50 percent.
Embodiment 95 is an article according to embodiment 94, wherein portions of the light redirecting area that are not part of the light redirecting region are clear enough to allow a user to see through the construction.
Embodiment 96 is the article of any of embodiments 94 to 95, wherein the optical haze is in a range of 20 to 75 percent and the optical clarity is in a range of 5 to 40 percent.
Embodiment 97 is the article of any of embodiments 94 to 95, wherein the optical haze is in a range of 25 to 65 percent and the optical clarity is in a range of 7 to 37 percent.
Embodiment 98 is the article of any of embodiments 94 to 95, wherein the optical haze is in a range of 30 to 60 percent and the optical clarity is in a range of 10 to 35 percent.
Embodiment 99 is the article of any of embodiments 94 to 98, wherein the diffuser has a structured surface adapted to diffuse visible light.
Embodiment 100 is the article of embodiment 99, wherein the structured surface comprises asymmetric light diffusing surface structures.
Embodiment 101 is the article of embodiment 100, wherein the structured surface has a surface angle distribution having a first half width at half maximum (HWHM) in a first direction and a second surface angle distribution having a second HWHM in a second direction different from the first direction, wherein the first HWHM is different from the second HWHM.
Embodiment 102 is the article of embodiment 101, wherein a ratio of the first HWHM to the second

HWHM is greater than 1.1.
Embodiment 103 is the article of any of embodiments 101 to 102, wherein the structured surface is more diffusive along the first direction and less diffusive along the second direction, the second direction orthogonal to the first direction.
Embodiment 104 is the article of any of embodiments 101 to 103, where the microstructured prismatic elements extend in the first direction.
Embodiment 105 is the article of any of embodiments 99 to 104, wherein the structured surface comprises lenticular structures.
Embodiment 106 is the article of any of embodiments 99 to 105, wherein the structured surface comprises approximately semi-ellipsoidal or approximately semi-biconic structures.
Embodiment 107 is the article of any of embodiments 99 to 106, wherein the structured surface comprises randomly or pseudo-randomly distributed structures.
Embodiment 108 is the article of any of embodiments 99 to 107, wherein at least 80 percent of the structured surface has a slope magnitude greater than about 1 degree.
Embodiment 109 is the article of any of embodiments 99 to 108, wherein at least 90 percent of the structured surface has a slope magnitude greater than about 1 degree.
Embodiment 110 is the article of any of embodiments 99 to 104, wherein less than 2 percent of the structured surface has a slope magnitude less than 1 degree.
Embodiment 111 is a method of making an article comprising: providing a first substrate having a first major surface and a second major surface opposite the first major surface;
applying an adhesive layer to the first major surface of the first substrate;
wherein the adhesive layer has a first major surface and a second major surface opposite the first major surface; and wherein the second major surface of the adhesive layer is immediately adjacent the first major surface of the first substrate;
printing one or more barrier elements on the first major surface of the adhesive layer;
structuring a surface of at least some of the one or more barrier elements to form a diffuser comprising the structured surface;
setting the one or more barrier elements;
laminating a light redirecting layer on the first major surface of the adhesive layer;
wherein the light redirecting layer comprises one or more microstructured prismatic elements on its first major surface defining a light redirecting area;
wherein the total surface area of the one or more barrier elements is greater than 60% of the light redirecting area;
wherein the first major surface of the adhesive layer has a first region and a second region;
wherein the first region of the first surface of the adhesive layer is in contact with the one or more barrier elements;
wherein the second region of the first surface of the adhesive layer is in contact with one or more microstructured prismatic elements;
wherein the article allows transmission of visible light and the diffuser has an optical haze of 20 to 85 percent and an optical clarity of no more than 50 percent.
Embodiment 112 is the method of embodiment 111, wherein the optical haze is in a range of 20 to 75 percent and the optical clarity is in a range of 5 to 40 percent.
Embodiment 113 is the method of embodiment 111, wherein the optical haze is in a range of 25 to 65 percent and the optical clarity is in a range of 7 to 37 percent.
Embodiment 114 is the method of embodiment 111, wherein the optical haze is in a range of 30 to 60 percent and the optical clarity is in a range of 10 to 35 percent.
Embodiment 115 is the method of any of embodiments 111-114, wherein the structured surface comprises asymmetric light diffusing surface structures.
Embodiment 116 is the method of embodiment 115, wherein the structured surface has a surface angle distribution having a first half width at half maximum (HWHM) in a first direction and a second surface angle distribution having a second HWHM in a second direction different from the first direction, wherein the first HWHM is different from the second HWHM.
Embodiment 117 is the method of embodiment 116, wherein a ratio of the first HWHM to the second HWHM is greater than 1.1.
Embodiment 118 is the method of any of embodiments 116 to 117, wherein the structured surface is more diffusive along the first direction and less diffusive along the second direction, the second direction orthogonal to the first direction.
Embodiment 119 is the method of any of embodiments 116 to 118, where the microstructured prismatic elements extend in the first direction.
Embodiment 120 is the method of any of embodiments 111 to 119, wherein the structured surface comprises lenticular structures.
Embodiment 121 is a method according to any of the preceding embodiments directed to methods,
wherein the structured surface comprises approximately semi-ellipsoidal or approximately semi-biconic structures.
Embodiment 122 is a method according to any of the preceding embodiments directed to methods,
wherein the structured surface comprises randomly or pseudo-randomly distributed structures.
Embodiment 123 is a method according to any of the preceding embodiments directed to methods,
wherein at least 80 percent of the structured surface has a slope magnitude greater than about 1 degree.
Embodiment 124 is a method according to any of the preceding embodiments directed to methods,
wherein at least 90 percent of the structured surface has a slope magnitude greater than about 1 degree.
Embodiment 125 is a method according to any of the preceding embodiments directed to methods,
wherein less than 2 percent of the structured surface has a slope magnitude less than 1 degree.
Embodiment 126 is a method according to any of the preceding embodiments directed to methods,
wherein printing of the one or more barrier elements occurs by direct or offset printing and by process chosen from flexographic printing, gravure printing, screen printing, letterpress printing, lithographic printing, ink-jet printing, digitally controlled spraying, thermal printing, and combinations thereof.
Embodiment 127 is a method according to any of the preceding embodiments directed to methods,
wherein setting the one or more barrier elements occurs by a method chosen from UV radiation curing, e-beam-radiation curing, thermal curing, chemical curing, and cooling.
Embodiment 128 is a method according to any of the preceding embodiments directed to methods,
wherein the first substrate comprises a diffuser chosen from bulk diffusers, surface diffusers, and embedded diffusers or combinations thereof.
Embodiment 129 is a method according to any of the preceding embodiments directed to methods,
wherein the light redirecting layer comprises a light redirecting substrate, and wherein the one or more microstructured prismatic elements are on the light redirecting substrate.
Embodiment 130 is a method according to any of the preceding embodiments directed to methods,
wherein the total surface area of the one or more barrier elements is greater than 65% of the light redirecting area.
Embodiment 131 is a method according to any of the preceding embodiments directed to methods,
wherein the total surface area of the one or more barrier elements is greater than 70% of the light redirecting area.
Embodiment 132 is a method according to any of the preceding embodiments directed to methods,
wherein the total surface area of the one or more barrier elements is greater than 80% of the light redirecting area.
Embodiment 133 is a method according to any of the preceding embodiments directed to methods,
wherein the total surface area of the one or more barrier elements is greater than 90% of the light redirecting area.
Embodiment 134 is a method according to any of the preceding embodiments directed to methods,
wherein the total surface area of the one or more barrier elements is greater than 95% of the light redirecting area.
Embodiment 135 is a method according to any of the preceding embodiments directed to methods,
wherein the total surface area of the one or more barrier elements is greater than 98% of the light redirecting area.
Embodiment 136 is a method according to any of the preceding embodiments directed to methods,
wherein a barrier element diffuses visible light.
Embodiment 137 is a method according to any of the preceding embodiments directed to methods,
wherein a barrier element comprises a diffusing agent.
Embodiment 138 is a method according to any of the preceding embodiments directed to methods,
wherein a barrier element comprises particles as a diffusing agent
Embodiment 139 is a method according to any of the preceding embodiments directed to methods,
wherein the adhesive layer comprises a diffusing agent.
Embodiment 140 is a method according to any of the preceding embodiments directed to methods,
wherein the adhesive layer comprises particles as a diffusing agent.
Embodiment 141 is a method according to any of the preceding embodiments directed to methods,
wherein the window film adhesive layer comprises a diffusing agent.
Embodiment 142 is a method according to any of the preceding embodiments directed to methods,
wherein the window film adhesive layer comprises particles as a diffusing agent.
Embodiment 143 is a method according to any of the preceding embodiments directed to methods,
wherein the surface roughness of a barrier element provides visible-light diffusing properties to the barrier element.
Embodiment 144 is a method according to any of the preceding embodiments directed to methods,
wherein a barrier element comprises one or more light stabilizers.
Embodiment 145 is a method according to any of the preceding embodiments directed to methods,
wherein the material of the barrier elements has been cured using UV radiation or heat.
Embodiment 146 is a method according to any of the preceding embodiments directed to methods,
wherein the barrier elements are laid out in a pattern chosen from a repeating 1-dimensional pattern, a repeating 2-dimensional pattern, and a random-looking 1- or 2-dimensional pattern.
Embodiment 147 is a method according to any of the preceding embodiments directed to methods,
wherein the center-to-center distance between barrier elements defines the pitch; and wherein the average pitch in the article is between 0.035 millimeters and 100 millimeters.
Embodiment 148 is a method according to any of the preceding embodiments directed to methods,
wherein the center-to-center distance between barrier elements defines the pitch; and wherein the average pitch in the article is between 0.1 millimeters and 10 millimeters.
Embodiment 149 is a method according to any of the preceding embodiments directed to methods,
wherein the center-to-center distance between barrier elements defines the pitch; and wherein the average pitch in the article is between 0. 5 millimeters and 5 millimeters.
Embodiment 150 is a method according to any of the preceding embodiments directed to methods,
wherein the center-to-center distance between barrier elements defines the pitch; and wherein the average pitch in the article is between 0.75 millimeters and 3 millimeters.
Embodiment 151 is a method according to any of the preceding embodiments directed to methods,
wherein the width of a channel of the second region of the first surface of the adhesive layer defines a gap; and wherein the average gap in the article is between 0.01 millimeters and 40 millimeters.
Embodiment 152 is a method according to any of the preceding embodiments directed to methods,
wherein the adhesive in the adhesive layer is chosen from a pressure sensitive adhesive, a thermoset adhesive, hot melt adhesive, and a UV curable adhesive.
Embodiment 153 is a method according to any of the preceding embodiments directed to methods,
wherein the adhesive in the adhesive layer is a pressure sensitive adhesive.
Embodiment 154 is a method according to any of the preceding embodiments directed to methods,
wherein the adhesive layer comprises one or more UV stabilizers.
Embodiment 155 is a method according to any of the preceding embodiments directed to methods,
wherein the refractive index of the material of the microstructured prismatic elements matches the refractive index of the adhesive layer.
Embodiment 156 is a method according to any of the preceding embodiments directed to methods, further comprising a first substrate adjacent the second major surface of the adhesive layer.
Embodiment 157 is a method according to any of the preceding embodiments directed to methods,
wherein the peel strength for the bond between the first substrate and the light redirecting layer is from 25 g/in to 2,000 g/in.
Embodiment 158 is a method according to any of the preceding embodiments directed to methods,
wherein the peel strength for the bond between the first substrate and the light redirecting layer is greater than 300 g/in.
Embodiment 159 is a method according to any of the preceding embodiments directed to methods,
wherein the peel strength for the bond between the first substrate and the light redirecting layer is greater than 400 g/in.
Embodiment 160 is a method according to any of the preceding embodiments directed to methods,
wherein the peel strength for the bond between the first substrate and the light redirecting layer is greater than 500 g/in.
Embodiment 161 is a method according to any of the preceding embodiments directed to methods,
wherein the second region of the first major surface of the adhesive layer fills the space between at least two immediately adjacent microstructured prismatic elements.
Embodiment 162 is a method according to any of the preceding embodiments directed to methods,
wherein the article has a rectangular or square shape and the edge of all four sides is sealed.
Embodiment 163 is a method according to any of the preceding embodiments directed to methods,
wherein the article has a rectangular or square shape and the edge of at least one side is sealed by the adhesive layer.
Embodiment 164 is a method according to any of the preceding embodiments directed to methods,
wherein the article has a rectangular or square shape and the edge of at least one side is sealed with a sealing agent.
Embodiment 165 is a method according to any of the preceding embodiments directed to methods,
wherein the article has a rectangular or square shape and the edge of at least one side is sealed with an edge sealing tape.
Embodiment 166 is a method according to any of the preceding embodiments directed to methods,
wherein the article has a rectangular or square shape and the edge of at least one side is thermally sealed.
Embodiment 167 is a method according to any of the preceding embodiments directed to methods,
wherein the article has a circular or ellipsoidal shape and the edge of the article is sealed all around.
Embodiment 168 is a method according to any of the preceding embodiments directed to methods,
wherein the article has a circular or ellipsoidal shape and at least a portion of the edge of the article is sealed by the adhesive layer.
Embodiment 169 is a method according to any of the preceding embodiments directed to methods,
wherein the article has a circular or ellipsoidal shape and at least a portion of the edge of the article is sealed with a sealing agent.
Embodiment 170 is a method according to any of the preceding embodiments directed to methods,
wherein the article has a circular or ellipsoidal shape and at least a portion of the edge of the article is sealed with an edge sealing tape.
Embodiment 171 is a method according to any of the preceding embodiments directed to methods,
wherein the article has a circular or ellipsoidal shape and at least a portion of the edge of the article is thermally sealed.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An article comprising:
a light redirecting layer comprising a first major surface and a second major surface;
one or more barrier elements;
an adhesive layer;
wherein the light redirecting layer comprises one or more microstructured prismatic elements at its first major surface defining a light redirecting area;
wherein the total surface area of the one or more barrier elements is greater than 60% of the light redirecting area;
wherein the adhesive layer comprises a first major surface and a second major surface;
wherein the first major surface of the adhesive layer has a first region and a second region;
wherein the first region of the first surface of the adhesive layer is in contact with one or more barrier elements;
wherein the second region of the first surface of the adhesive layer is in contact with one or more microstructured prismatic elements;
wherein the article allows transmission of visible light; and
wherein either at least one of the one or more barrier elements or an optional diffuser disposed adjacent the light redirecting layer or adjacent the adhesive layer has an optical haze of 20 to 85 percent and an optical clarity of no more than 50 percent.

2. The article of claim 1, wherein the optical haze is in a range of 20 to 75 percent and the optical clarity is in a range of 5 to 40 percent.

3. The article of claim 1, wherein the optical haze is in a range of 25 to 65 percent and the optical clarity is in a range of 7 to 37 percent.

4. The article of claim 1, wherein the optical haze is in a range of 30 to 60 percent and the optical clarity is in a range of 10 to 35 percent.

5. The article of claim 1, wherein the at least one of the one or more barrier elements has a structured surface adapted to diffuse visible light.

6. The article of claim 1, wherein the article includes the optional diffuser and the optional diffuser has a structured surface adapted to diffuse visible light.

7. The article of claim 6, wherein the structured surface comprises asymmetric light diffusing surface structures.

8. The article of claim 7, wherein the structured surface has a surface angle distribution having a first half width at half maximum (HWHM) in a first direction and a second surface angle distribution having a second HWHM in a second direction different from the first direction, wherein the first HWHM is different from the second HWHM.

9. The article of claim 7, wherein the structured surface is more diffusive along a first direction and less diffusive along a second direction orthogonal to the first direction.

10. A film comprising an article according to claim 1,
wherein the article further comprises a second substrate adjacent the second major surface of the adhesive layer;
wherein the article further comprises a window film adhesive layer adjacent the second major surface of the light redirecting layer; and
wherein the article optionally further comprises a liner adjacent the window film adhesive layer.

11. A film comprising the article of claim 1,
wherein the total surface area of the one or more barrier elements is greater than 90% of the light redirecting area;
wherein the article further comprises:
a first substrate adjacent the second major surface of the adhesive layer, the first substrate including the optional diffuser;
wherein the optional diffuser has the optical haze of 20 to 85 percent and the optical clarity of no more than 50 percent; and
a window film adhesive layer adjacent the second surface of the light redirecting layer;
wherein the film optionally further comprises a liner immediately adjacent the window film adhesive layer.

12. A film comprising the article of claim 1,
wherein the total surface area of the one or more barrier elements is greater than 90% of the light redirecting area;
wherein the article further comprises:
the optional diffuser adjacent the second major surface of the light redirecting layer;
a first substrate immediately adjacent the adhesive layer;
a window film adhesive layer immediately adjacent the first substrate;
wherein the film optionally further comprises a liner immediately adjacent the window film adhesive layer,
wherein the optional diffuser has the optical haze of 20 to 85 percent and the optical clarity of no more than 50 percent.

13. A film comprising the article of claim 1,
wherein the total surface area of the one or more barrier elements is greater than 90% of the light redirecting area;
wherein the article comprises the optional diffuser adjacent the second major surface of the light redirecting layer;
wherein the film optionally further comprises a liner immediately adjacent the adhesive layer;
wherein the optional diffuser has the optical haze of 20 to 85 percent and the optical clarity of no more than 50 percent.

14. The film of claim 13, wherein the optical haze is in a range of 30 to 60 percent and the optical clarity is in a range of 10 to 35 percent.

15. An article comprising:
a light redirecting layer comprising a first major surface and a second major surface;
one or more barrier elements;
an adhesive layer;
wherein the light redirecting layer comprises one or more microstructured prismatic elements at its first major surface defining a light redirecting area;
wherein the total surface area of the one or more barrier elements in at least a portion of the article defined as a light redirecting region is greater than 60% of the light redirecting area;
wherein the adhesive layer comprises a first major surface and a second major surface;
wherein the first major surface of the adhesive layer has a first region and a second region;
wherein the first region of the first surface of the adhesive layer is in contact with one or more barrier elements;
wherein the second region of the first surface of the adhesive layer is in contact with one or more microstructured prismatic elements;
wherein the article allows transmission of visible light;
wherein the one or more barrier elements comprises a diffuser having an optical haze of 20 to 85 percent and an optical clarity of no more than 50 percent.

16. The article of claim 15, wherein the optical haze is in a range of 30 to 60 percent and the optical clarity is in a range of 10 to 35 percent.

17. A method of making an article comprising:
providing a first substrate having a first major surface and a second major surface opposite the first major surface;
applying an adhesive layer to the first major surface of the first substrate;
wherein the adhesive layer has a first major surface and a second major surface opposite the first major surface; and wherein the second major surface of the adhesive layer is immediately adjacent the first major surface of the first substrate;
printing one or more barrier elements on the first major surface of the adhesive layer;
structuring a surface of at least some of the one or more barrier elements to form a diffuser comprising the structured surface;
setting the one or more barrier elements;
laminating a light redirecting layer on the first major surface of the adhesive layer;
wherein the light redirecting layer comprises one or more microstructured prismatic elements at its first major surface defining a light redirecting area;
wherein the total surface area of the one or more barrier elements is greater than 60% of the light redirecting area;
wherein the first major surface of the adhesive layer has a first region and a second region;
wherein the first region of the first surface of the adhesive layer is in contact with the one or more barrier elements;
wherein the second region of the first surface of the adhesive layer is in contact with one or more microstructured prismatic elements;
wherein the article allows transmission of visible light and the diffuser has an optical haze of 20 to 85 percent and an optical clarity of no more than 50 percent.

18. The article of claim 1 including the optional diffuser, wherein the optional diffuser has the optical haze of 20 to 85 percent and the optical clarity of no more than 50 percent.

19. The article of claim 1, wherein the at least one of the one or more barrier elements has the optical haze of 20 to 85 percent and the optical clarity of no more than 50 percent.

20. The article of claim 5, wherein the structured surface comprises asymmetric light diffusing surface structures.

21. The film of claim 11, wherein the optical haze is in a range of 30 to 60 percent and the optical clarity is in a range of 10 to 35 percent.

22. The film of claim 12, wherein the optical haze is in a range of 30 to 60 percent and the optical clarity is in a range of 10 to 35 percent.
